(19) United States
(12) Patent Application Publication
(10) Pub. No.: US 2005/0016276 A1
(43) Pub. Date: Jan. 27, 2005

(54) Frequency encoding of resonant mass sensors

(75) Inventors: Shenheng Guan, Palo Alto, CA (US); Ralph B. Nielsen, San Jose, CA (US)

Correspondence Address: Dr. Shenheng Guan, 879 Newell Place, Palo Alto, CA, 94303, US

(73) Assignee: Palo Alto Sensor Technology Innovation, Palo Alto, CA (US)

(21) Appl. No.: 10/861,583

(22) Filed: Jun. 4, 2004

Related U.S. Application Data
(60) Provisional application No. 60/476,886, filed on Jun. 6, 2003.

(51) Int. Cl. G01N 29/00; G01N 29/04

(52) U.S. Cl. 73/579

(57) ABSTRACT

A method for the detection of analytes using resonant mass sensors or sensor arrays comprises frequency encoding each sensor element, acquiring a time-domain resonance signal from the sensor or sensor array as it is exposed to analyte, detecting change in the frequency or resonant properties of each sensor element using a Fourier transform or other spectral analysis method, and classifying, identifying, and/or quantifying analyte using an appropriate data analysis procedure. Frequency encoded sensors or sensor arrays comprise sensor elements with frequency domain resonance signals that can be uniquely identified under a defined range of operating conditions. Frequency encoding can be realized either by fabricating individual sensor elements with unique resonant frequencies or by tuning or modifying identical resonant devices to unique frequencies by adding or removing mass from individual sensor elements. The array of sensor elements comprises multiple resonant structures that may have identical or unique sensing layers. The sensing layers influence the sensor elements' response to analyte. Time-domain signal is acquired, typically in a single data acquisition channel, and typically using either (1) a pulsed excitation followed by acquisition of the free oscillatory decay of the entire array or (2) a rapid scan acquisition of signal from the entire array in a direct or heterodyne configuration. Spectrum analysis of the time domain data is typically accomplished with Fourier transform analysis. The methods and sensor arrays of the invention enable rapid and sensitive analyte detection, classification and/or identification of complex mixtures and unknown compounds, and quantification of known analytes, using sensor element design and signal detection hardware that are robust, simple and low cost.

### REFERENCES CITED

References Cited
U.S. PATENT DOCUMENTS

| | | | |
|---|---|---|---|
| 4,065,959 | 03 Jan-78 | Richardson | 73/54.13 |
| 4,484,468 | 27 Nov-84 | Gau, et al | 73/54.35 |
| 4,741,200 | 03 May-88 | Hammerle | 73/54.25 |
| 4,761,545 | 02 Aug-88 | Marshall, et al. | 250/291 |
| 4,783,987 | 15 Nov-88 | Hager et al. | 73/32. |
| 4,920,787 | 01 May-90 | Dual, et al. | 73/54.41 |
| 4,945,234 | 31 Jul-90 | Goodman, et al. | 250/291 |
| 5,013,912 | 07 May-91 | Guan | 250/282 |
| 5,151,110 | 09 Sep-92 | Bein, et al. | 95/140 |
| 5,198,716 | 30 Mar-93 | Godshall et al. | 310/349. |
| 5,201,215 | 13 Apr-93 | Granstaff et al. | 73/54. |
| 5,211,054 | 18 May-93 | Muramatsu, et al | 73/64.42 |
| 5,224,972 | 06 Jul-93 | Frye, et al. | 95/9 |
| 5,325,704 | 05 Jul-94 | Mariani, et al. | 73/24.06 |
| 5,365,778 | 22 Nov-94 | Sheen et al. | 73/54. |
| 5,416,448 | 16 May-95 | Wessendorf | 331/116. |
| 5,469,369 | 21 Nov-95 | Rose-Pehrsson, et al. | 702/27 |
| 5,488,866 | 06 Feb-96 | Ravel, et al. | 73/579 |
| 5,503,003 | 02 Apr-96 | Brookfield | 73/54. |
| 5,526,287 | 11 Jun-96 | French | 364/550. |
| 5,541,855 | 30 Jul-96 | Enzler et al. | 364/552. |
| 5,589,396 | 31 Dec-96 | Frye, et al. | 436/73 |
| 5,661,226 | 26 Aug-97 | Bowers, et al. | 73/24.01 |
| 5,731,510 | 24 Mar-98 | Jones, et al. | 73/23.31 |
| 5,734,098 | 31 Mar-98 | Kraus et al. | 73/61. |
| 5,741,961 | 21 Apr-98 | Martin et al. | 73/32. |
| 5,798,452 | 25 Aug-98 | Martin et al. | 73/32. |
| 5,827,952 | 27 Oct-98 | Mansure et al. | 73/61. |
| 5,839,094 | 17 Nov-98 | French | 702/91. |
| 6,044,694 | 04 Apr-00 | Anderson, et al. | 73/54.41 |
| 6,141,625 | 31 Oct-00 | Smith, et al. | 702/50 |
| 6,171,867 | 09 Jan-01 | Feucht , et al. | 436/124 |
| 6,257,048 | 10 Jul-01 | Hietala, et al. | 73/24.01 |
| 6,321,588 | 27 Nov-01 | Bowers, et al. | 73/24.01 |
| 6,336,353 | 08 Jan-02 | Matsiev, et al. | 73/24.06 |
| 6,350,609 | 26 Feb-02 | Morozov, et al. | 435/283.1 |
| 6,360,585 | 26 Mar-02 | Potyrailo, et al. | 73/24.06 |
| 6,393,895 | 28 May-02 | Matsiev, et al | 73/24.06 |
| 6,408,250 | 18 Jun-02 | Grate, et al. | 702/30 |
| 6,439,034 | 27 Aug-02 | Farone, et al | 73/54.24 |
| 6,494,079 | 17 Dec-02 | Matsiev, et al | 73/24.05 |

### OTHER PUBLICATIONS

Albert, K. J. et al. Chem Rev. 100 (2000) pp. 2595-2626
Ballantine, D. S. Jr. et al. Acoustic wave sensors: theory, design, and physico-chemical applications, Academy Press, San Diego, 1996.
Boeker, P. et al. Sensors and Actuators B 70 (2000) pp. 37-42.
Buttry, D. A.; Ward, M. D. Chem. Rev. 92 (1992) pp. 1355-1379.
Chen, G. Y., et al. Rev. Sci. Instrum., 65 (1994) pp. 2532-2537.
Chen L. Rapid Commun. Mass Spectrom. 1 (1987) p. 39.
Comisarow, M. B.; Marshall, A. G. Chem. Phys. Lett. 25 (1974) pp. 282-285.
Diller, D. E. J. Chem. Phys. 42, (1965) pp. 2089-2100.
Ernst, R. R.; Anderson, W. A. Rev. Sci. Instrum. 37 (1966) pp. 93-102.
Ernst, R. R; Bodenhausen, G.; Wokaun, A. Principles of Nuclear Magnetic Resonance in One and Two Dimensions; Clarendon: Oxford, 1987.
Fish, M. R.; Moeller, R. P.; Carome, E. F. (1976) J. Acoust. Soc. Am. 60, pp. 623-625.
Grate, J. W. Chem. Rev. 100 (2000) pp. 2627-2648.
Grate, J. W.; Martin, S. J.; White, R. M. Anal. Chem. 65, (1993) pp. 940A and 987A.
Guan, S., J. Chem. Phys. 91 (1989) p. 775.
Guan, S. and McIver, R. T. J. Chem. Phys. 92 (1990) p. 5841
Guan, S. and Marshall, A. G. Int. J. Mass Spectrom. Ion Processes 157/158 (1996) pp. 5-37
Hauck, S.; Drost, S.; Prohaska, E.; Wolf, H.; Dubel, S. Protein-Protein Interactions, (2002) pp. 273-283.
Jurs, P. C.; Bakken, G. A.; McClelland, H. E. Chem. Rev. 100 (2000), pp. 2649-2678.
Kanazawa, K. K.; Gordon, J. G. II Anal. Chem. 57 (1985)a pp. 1770-1771.
Kanazawa, K. K.; Gordon, J. G. II Anal. Chimica Acta 175 (1985)b pp. 99-105.
Karrai, K. Ecole Thematique du CNRS on Near-Field Optics, March 2000, La Londe Maures, France.
King, W. H. Jr. Anal Chem. 36 (1964) p. 1735.
Marshall et al. Am. Chem. Soc. Symp. Ser. 359 (1987) p. 21
Marshall, A. G.; Verdun, F. R. Fourier Transforms in Optical, NMR, and Mass Spectrometry: A User's Handbook; Elsevier: Amsterdam, 1990.
Martin, S. J.; Granstaff, V. E.; Frye, G. C. Anal. Chem. 63, (1991), pp. 2272-2281.
Mason, W. P. Physical Acoustics and the Properties of Solid, D. van Norstrand Company, Inc.: New Jersey, 1958.
Mason, W. P. Electromechanical Transducers and Wave Filters, D. van Norstrand Company, Inc. New York, 1948.
Matsiev, L. F. IEEE Ultrasonic Symposium (1999) pp. 457-460.
Matsiev, L. F. IEEE Ultrasonic Symposium (2000) pp. 427-434.
Matsiev, L. F.; Bennett, J. W.; McFarland, E. W. IEEE Ultrasonic Symposium (1998) pp. 459-462.
Nakamura, K.; Nakamoto, T.; Moriizumi T. Sensors and Actuators B 69 (2000) 295-301.
Nakata, S. et al. Anal. Chem. 68 (1996) pp. 2067-2072.
Nomura, T.; Minemura, A. Nippon Kagaku (1980) p. 1261.
Oden, P. I., et al. Appl. Phys. Lett. 68 (1996) pp. 3814-3816
Ricoo, A. J.; Martin, S. J. Sensors and Actuators B 10 (1993) pp. 123-131.
Salt, D. Hy-Q Handbook of Quartz Crystal Devices, Van Norstrand Reinhold (UK), 1987.
Sauerbrey, G., Z. Phys. 155 (1959) pp. 206-221.
Staudte, J. H. Proc. 27^{th} Annu. Symp. Freq. Control (1973) p. 50.
Tan, H. et al. Analytica Chimica Acta 353 (1997) pp. 29-35.
Tatsuma et al. Anal. Chem. 71 (1999) pp. 3632-36.
Thompson, M. et al. Analyst 116 (1991) pp. 881-890.
Tomlinson, B. L. and Hill, H. D. W. J. Chem. Phys. 59 (1973) p. 1775.
Trolier, S.; Xu, Q. C.; Newnham, R. E. Mat. Res. Bull. 22 (1987), pp. 1267-1274.
Vaughan, R. D.; Carter, R. M.; O'Sullivan, C. K.; Guilbault, G. G. Anal. Lett. 36 (2003) pp. 731-747
Wegener, J.; Janshoff, A.; Steinem, C. Cell Biochemistry and Biophysics 34 (2001) pp. 121-51.
Welber, B. Phys. Rev. 19 (1960) pp. 1816-1822.
Wessendorf, K. O. Proc. IEEE Intl. Freq. Control Symp. (2001) pp. 400-407.

### RELATED APPLICATIONS

The present application claim the benefit of, and priority to U.S. Ser. No. 60/476,886 entitled “Fourier Transform Detection of Frequency Encoded Quartz Microbalance Sensor Array” filed on Jun. 6, 2003 by Shenheng Guan and Ralph B. Nielsen, which is hereby incorporated by reference for all purposes.

### FIELD OF THE INVENTION

The present invention relates generally to methods of signal acquisition and detection of resonant or acoustic sensors or sensor arrays for detection of analytes in fluids, either gaseous or liquid. Applications of this invention include detection of chemicals and biochemicals, automotive sensing, materials processing, safety and environmental monitoring, explosive and chemical weapon detection, product quality control, drug and material discovery, and medical diagnostics.

### DESCRIPTION OF THE PRIOR ART

Quartz crystal oscillators have been widely used as frequency control devices in the field of communications. The historical account for development in this field can be found in David Salt's “Handbook of Quartz Crystal” (Salt, 1987). Piezoelectricity was discovered by the Curie brothers in 1880. Cady developed the first quartz crystal oscillator in 1921 (Cady, 1964). AT-cut quartz oscillators with very low temperature coefficients were introduced in 1934 (Lack et al., 1934). Application of acoustic devices for frequency control requires stable resonant frequency and suitable frequency ranges. Development in the field has paved an important foundation for application of acoustic sensors for chemical and biochemical analysis. The development includes theoretical understanding of acoustic resonators by equivalent circuits (Mason, 1948). Commercial demand for high quality quartz crystal resonators has resulted in availability of abundant quantities of low cost devices. Table 1 summarizes several acoustic device types for frequency control applications which can also used as sensors for chemical analysis.

TABLE 1

| | | Typical |
|---|---|---|
| | | Frequency Control |
| Device Type | Frequency (Hz) | Applications |
| Tuning Fork | 1 kHz-500 kHz | Timing for watches |
| Thickness Shear | 1 MHz-30 MHz Fundamental | Timing |
| Mode (TSM) | 30 MHz-150 MHz Overtune | |
| | 50 Mz-450 MHz Inverted Mesa | |
| Surface Acoustic | 10 MHz-2 GHz | Timing and filtering |
| Wave (SAW) | | |

Quartz crystal devices have found many applications other than frequency control, including application as sensors. Individual thickness shear mode (TSM) devices (known also as of quartz crystal microbalance, QCM) respond to minute changes in mass deposited on their surface and are used to monitor vacuum deposition processes in the semiconductor industry. Tuning fork and TSM devices have been used to monitor physical properties of liquid, such as density, viscosity, etc (Mason, 1958). A group of quartz crystal resonators can be assembled to form a sensor array for a wide range of applications.

Sensor array systems for chemical analysis in which analytical selectivity is realized by non-specific, differential response of various elements in the array are known as cross-reactive chemical sensor arrays (Albert, 2000). Because they mimic human olfactory receptors for odor detection, they are also called “electronic noses”. Previously developed classes of cross-reactive chemical sensor arrays include metal oxide arrays, metal oxide field effect transistor (MOSFET) arrays, conductive polymer chemiresistor arrays, fiber optical sensing arrays, electrochemical sensor arrays, and acoustic sensor arrays. As an emerging area, all of these types of cross-reactive sensor arrays suffer from significant technical challenges. Resonant sensor arrays are increasingly seen as perhaps the most promising type because of high sensitivity, well-understood mass-based detection mechanisms, and good mechanical and performance stability. However, the resonant sensor arrays described previously suffer from prohibitive hardware cost associated with multichannel excitation and detection, and/or performance issues associated with frequency scanning and slow, non-simultaneous signal acquisition.

Chemical sensing of an acoustic sensor is based on the resonance frequency change due to added mass on the sensor's surface, described by the so-called Sauerbrey equation (Sauerbrey, 1959)
Δf=−2.3×10⁶f²Δm/A Equation 1
in which Δf is the change in frequency, f is the resonant frequency of the crystal, Δm is the added mass and A is the area of the mass loading. Gas-phase microgravimetric measurement was described by King (King, 1964). The field of acoustic resonance sensors for detection of chemicals and biochemicals has been surveyed in books (Ballantine, 1996) and review articles (Thompson, 1991; Buttry, 1992; Grate, 1993, 2000).

A monolithic multichannel quartz crystal microbalance (QCM) array with different resonant frequencies was proposed and arrays with the same frequency were realized (Tasuma, 1999). A monolithic QCM array with heating structures for thermal modulation was studied (Boeker, 2000). Thermal modulation was applied on tin oxide semiconductor sensors and fast Fourier transform (FFT) was used to analyzed the modulation (Nakata, 1996). Monolithic multiple-frequency surface acoustic wave (SAW) devices were demonstrated (Ricco, 1993).

All of the previously described methods and devices for acquiring signal from resonant sensor arrays generally require either (1) complex hardware with independent data acquisition channels for each sensor in the array, or (2) suffer from slow detection of the array, often with serial detection of each element of the array, using a single data acquisition channel and signal switching systems, requiring long measurement times and lacking simultaneous detection of each array element. As a result, many potential applications of such sensor arrays cannot be realized because of prohibitive cost, deficient performance, or both. There remains an unmet need for methods and instrumentation to enable high-speed, high performance signal acquisition from multisensor acoustic or resonant arrays, without the expense of multichannel parallel detection systems or switching devices for serial detection of array elements.

Fast Fourier transform (FFT) methods have revolutionized many fields of chemical and analysis instrumentation, particularly as inexpensive and rapid computing has become readily available and integral to such instrumentation. FTIR, FTNMR, and FTICRMS have superior performance over their frequency scanning counterparts. The advantages include superior spectral resolution, versatile operation procedures, high-analysis speed, and simplification of hardware construction. Application of Fourier transform methods to nuclear magnetic resonance by Ernst and Anderson (Ernst, 1966) paved the road for successful development in FTNMR for chemical and biochemical analysis and magnetic resonance imaging (MRI) for medical diagnostics. Introduction of Fourier transform mass spectrometry by Comisarow and Marshall in 1974 (Comisarow, 1974) converted ICR spectroscopy from an arcane research tool for ion-molecular reactions into a widely used, powerful analytical method. Many of advantages of the Fourier transform technique can be realized when applied to acoustic resonant mass sensors, especially to acoustic resonant sensor arrays. Tan et al. report fast Fourier transform admittance analysis for a single thickness shear mode sensor by use of a commercial impedance analyzer (Tan et al., 1997). However, no general methods have been described that allow for rapid, inexpensive, high-quality data acquisition from arrays of resonant or acoustic sensors, particularly for large arrays used for applications such as “electronic nose” sensors, combinatorial chemistry applications, or industrial process control.

### SUMMARY OF THE INVENTION

One object of the invention is to provide a sensor or sensor array that is sensitive to complex mixtures of analytes that may be in the form of gaseous vapor mixtures or liquid mixtures. Another object of the invention is to provide a sensor or sensor array sensitive to large numbers of analyte samples, such as the large number of analyte samples encountered in combinatorial chemistry, high throughput screening, product quality control, and industrial process monitoring. Yet another object of the invention is to provide a sensor or sensor array with high responsiveness to analytes at low concentration or gaseous analytes with low vapor pressure. Another objective is to provide a rapid analysis method that is suitable for determination of steady-state analyte samples and dynamic samples in which the analyte is changing over time. It is a further object of this invention to provide a sensor or sensor array that can detect these analytes either using single measurements or using rapid, repeated measurement to provide near-continuous monitoring of analytes. It is yet another object of the invention to provide a sensor or sensor array that achieves high sensing performance using a stable, robust, simple and inexpensive apparatus. It is yet another object of the invention to provides a sensor or sensor array with well-understood mechanisms of operation, applicable to a range of applications.

We have found that these and other objectives are achieved by using frequency encoded resonant mass sensors or sensor arrays according to the methods of this invention. These methods generally comprise frequency encoding multiple sensor elements in the sensor or sensor array, acquiring a time-domain resonance signal from the sensor or sensor array as it is exposed to analyte, detecting change in the frequency or resonant properties of sensor elements, typically using a Fourier transform or other spectral analysis method, and classifying, identifying, and/or quantifying analyte using an appropriate data analysis procedure. Two distinct time-domain data acquisition methods of this invention have proven to be particularly useful. The first data acquisition method comprises applying an excitation pulse to all sensor elements of the sensor or sensor array, followed by acquisition of a time-domain signal or free oscillatory decay. The second data acquisition method comprises a rapid-scan excitation of the sensor elements of the sensor array, with simultaneous acquisition of time-domain data. As will be described further, these methods provide distinct advantages for particular embodiments and applications of this invention.

The sensor elements of the resonant sensor arrays of the invention typically comprise resonant piezoelectric devices. These may comprise devices of different physical size, frequency range, substrate thickness, and device geometry. Two particularly useful device geometries are thickness shear mode (TSM) devices and “tuning forks”, although many other types of devices are known and are suitable for use as sensor elements of the invention. The frequency encoded sensors or sensor arrays of this invention comprise multiple sensor elements with resonance signals that can be uniquely identified by their frequency domain response under a defined range of analyte concentration or operating conditions. Depending on the types of resonant mass sensors used, frequency encoding can be realized either by fabricating individual sensor elements with unique resonant frequencies or by tuning identical resonant devices to unique frequencies by adding or removing mass from individual sensor elements. These devices may be individually fabricated resonant structures or monolithic device arrays with multiple resonant regions within a single substrate. Each sensor element comprises both a resonant device and a sensing layer that influences the sensor elements' response to analyte. The sensor array may comprise sensor elements that have identical or unique sensing layers, depending on the application. In a particularly preferred embodiment, the sensing layers comprise various organic polymer coatings with differing affinities toward various analyte components. In yet another particularly preferred embodiment, the sensing layers comprise identical polymer coatings on encoded sensor elements that are exposed to different analytes or environments.

According to this invention, signal from a frequency encoded sensor array is acquired in acquired for multiple sensor elements. In preferred embodiments, time domain data is acquired using either (1) a pulsed excitation followed by detection of the free oscillatory decay of the resonant sensor array, or (2) a rapid scan method with simultaneous excitation and detection. Both acquisition methods can be carried out in a direct or heterodyne configuration. In the heterodyne configuration, frequency reference is generated by a local oscillator, typically a resonant device frequency encoded in the array but not exposed to analyte, and preferably in vacuum. In particularly preferred embodiments, multiple sensor elements are electrically connected into a common analog circuit from which the time-domain signal is simultaneously acquired for all sensor elements. In this preferred embodiment, a common electrical connection may also be used for excitation or actuation of resonance in the array, and the electrical connection for excitation or actuation may be identical or distinct from the connection used for data acquisition. The use of a common data acquisition channel with a frequency encoded array of the invention offers a major advantage over previous sensor array designs, requiring simpler and less costly apparatus for data acquisition while enabling detailed determination of individual sensor element resonance properties. In general, the pulsed excitation method is generally suitable for low frequency sensor devices such as typical tuning fork devices. The rapid scan method is generally suitable for high frequency devices, such as TSM and SAW devices.

Spectrum analysis of the time-domain data according to the invention may be carried out by any of several suitable approaches. One general approach is fast Fourier transform (FFT) analysis. As described previously, the FFT method has transformed many aspects of scientific and analytical instrumentation, and the ready availability of inexpensive computers make this approach very rapid and economical. However, other spectrum analysis approaches such as linear prediction and maximum entropy methods may also be advantageously used. In some embodiments, information related to analyte can be derived using raw data as acquired from the array, without a discrete spectrum analysis step.

Appropriate analysis of the sensor array signal allows for classification, identification or quantification of analytes such as complex mixtures or large numbers of samples, depending on the application. In preferred embodiments of this invention, the steps of spectrum analysis, any frequency domain data preprocessing, and classification, identification, or quantification of analytes are all completed automatically by the computational function of the analysis hardware and software. Analysis methods can range from simple linear calibration in the case of highly specific analyte sensing layers to multivariate analyses such as principal component analysis, least squares analysis, pattern recognition, neural network analysis, etc. Multivariate approaches are particularly useful with cross-reactive sensor arrays. In some cases, the frequency spectrum can be divided into well-separated regions where each individual sensor element's contribution to the spectrum is clearly identified and distinct from the contributions of other sensor elements. In such cases, simple classification of a single spectral attribute of each sensor element, such as peak resonance frequency, may be sufficient for high-quality analyte determination. In other cases, measurement of resonance peak width, peak integral, or continuous monitoring of peak movement during analysis may be required. In yet other cases, analyte determination may be carried out without such data reduction, using pattern recognition or other methods that do not require discrete identification of each sensor element's contribution to the frequency spectrum

Similarly, analysis may be carried out using fundamental principles and well-characterized sensor element attributes. For example, the determination of vapor concentration may be calculated by consideration of equilibrium partition coefficient of a particular vapor into well-defined sensing layers of known thickness on a sensor element with known linear mass sensitivity. Alternatively, analysis may be carried out without knowledge of specific sensing layer partition coefficients or sensor element response profiles. Sensor elements may exhibit linear response to mass loading (i.e., an idealized QCM element) or may have complex, non-linear response to changes in mass, sensing layer geometry, stiffness or viscosity, dielectric properties of analyte, and other variables of the analyte/sensing layer/resonant device interaction. In cases with complex interactions, a common approach is the use of calibration or training set analytes to observe sensor or sensor array response, classifying subsequent responses according to previous data using any of several known data correlation techniques.

The methods and sensor arrays of the invention are useful in many practical applications. In applications such as environmental sensing, “electronic noses”, and many industrial processes involving complex mixtures, a typical sensor or array comprises multiple sensor elements in the same environment, but differing both in resonant frequency and in the type or identity of the sensing layer. Such configurations typically allow for characterization of complex, multicomponent analytes, providing a “fingerprint” response that is quite sensitive to variations in analyte concentration or composition. For other applications, including some production control applications, combinatorial testing, high-throughput screening, and chemical imaging, it may be advantageous to use sensors or arrays where multiple sensor elements have essentially identical sensing layers, but differ in both resonant frequency and physical location. Such configurations typically allow for the screening or monitoring of multiple samples or locations for a single attribute, although detection of multiple attributes in multiple locations may also be possible.

### DESCRIPTION OF THE DRAWINGS

FIG. 1 shows an overall system diagram, showing interactions between the analyte, the sensor or sensor array, the analog circuit for direct sensor control and measurement, and the digital generation of waveforms for sensor actuation and computation of sensor response.

FIG. 2 is a schematic of the analyte-dependent response for n frequency-encoded resonant mass sensor elements in an array, shown for one implementation.

FIG. 3 is a time-domain data acquisition scheme for a frequency encoded tuning fork sensor array.

FIG. 4 is an excitation and data acquisition sequence diagram of a pulsed excitation resonant sensor system. The temporal separation of excitation and detection allows free oscillation decay (FOD) to be acquired without interference of the excitation source. Fourier transform of the FOD produces corresponding frequency-domain data.

FIGS. 5A and 5B are data collected from a two-element tuning fork sensor system. FIG. 5A is a graph of time domain free oscillation decay signal of both a paraffin wax coated and a PDMS coated sensor element in air. FIG. 5B is a graph of the frequency magnitude spectrum derived from the data in FIG. 5A.

FIGS. 6A through 6C are magnitude spectra of the two-element sensor system from FIG. 5 exposed to acetone (FIG. 6A, partial pressure of 170.1 torr), toluene (FIG. 6B, partial pressure of 22.3 torr), and 2-propanol (FIG. 6C, partial pressure of 33.5 torr), showing changes in resonant frequency of each sensor element in response to various analytes.

FIG. 7 is a graph of frequency shift data of frequency encoded, polymer-coated resonant tuning mass sensors exposed to organic vapors, as described in FIG. 6.

FIG. 8 is graph of data of peak widths of signals from each sensor element of a frequency-encoded, polymer-coated resonant tuning mass sensor array exposed to organic vapors, measured at half peak height.

FIGS. 9A and 9B are magnitude spectra of an uncoated, frequency encoded 9-device resonator array (FIG. 9A) and a polymer-coated, frequency encoded 9-element sensor array (FIG. 9B).

FIG. 10 is frequency shift data obtained from a frequency encoded, polymer-coated resonant tuning fork mass sensor array exposed to three organic vapors.

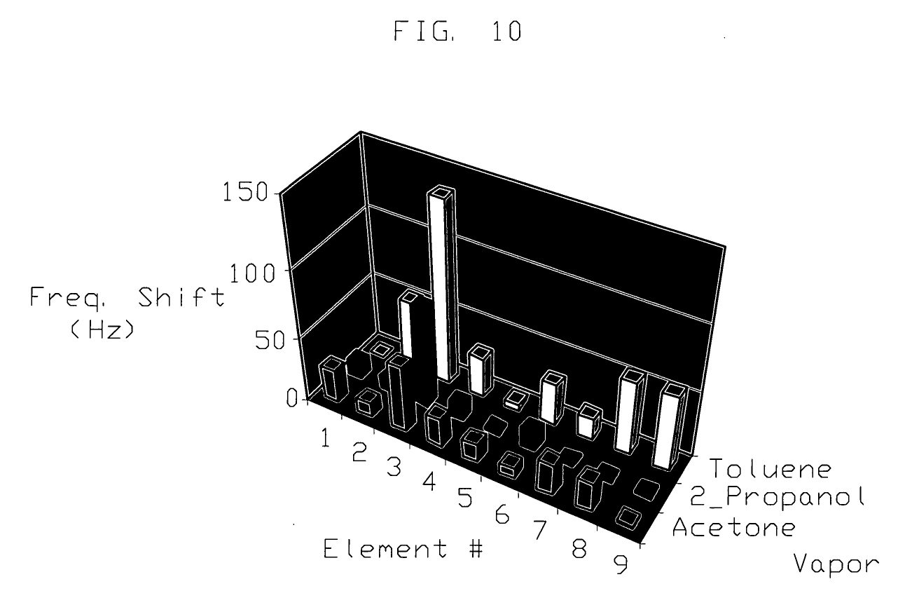

FIG. 11 is a diagram of one method for the fabrication of a monolithic, high-frequency sensor array starting from piezoelectric substrate, showing the steps of etching or milling to produce thin regions of higher frequency, the application of electrodes, frequency encoding, and the application of sensing layers.

FIG. 12 is schematic diagram showing two frequency encoding schemes for a QCM sensor element. The native device element comprises piezoelectric substrate 1201 and electrodes 1202. In one scheme, frequency encoding uses electroplating to add metal layer 1203, followed by application of a polymeric sensing layer 1204. In the second scheme of frequency encoding, application of sensing layer 1204 is followed by vapor deposition of metal layer 1203.

FIG. 13 is a schematic showing one implementation of frequency encoding for a four-element array, derived from a common device of frequency f₀. Frequency encoding of a reference element and four sensor elements by sequential application of metal and sensing layers results in sensor element signals that are distinct but contained within the available bandwidth of the data acquisition hardware.

FIG. 14 is a block diagram of a data acquisition system for a QCM sensor array.

FIGS. 15A through 15C are circuitry options for sensor arrays: parallel connection (FIG. 15A), serial connection (FIG. 15B), and serial connection with capacitor ladder (FIG. 15C).

FIG. 16 is a diagram of an equivalent circuit model of a QCM sensor element.

FIG. 17 is a flow diagram showing a typical data processing procedure relating time-domain sensor data to analyte characterization.

FIG. 18 is a flow diagram showing one option for data reduction to generate center frequencies of each sensor element in an array

FIG. 19 is a graph of time domain data from a four-element QCM sensor array

FIG. 20 is a magnitude spectrum of the four-element QCM sensor array

FIG. 21 is a graph of frequency changes of four sensor elements in contact with 8 chemical vapor environments

FIG. 22 is a principal component analysis plot of PC1 and PC2 showing classification of 8 chemical vapor environments detected by a four-element QCM sensor array

FIG. 23 is a diagram showing the use of a monolithic 4-element sensor array in contact with liquid aqueous analyte. Electrical isolation of electrodes on one side of the monolith allows the acquisition of data in the presence of water. Binding of analytes to sensing layers is shown schematically.

FIG. 24 is a block diagram showing data acquisition from a QCM sensor array, utilizing a directional coupler.

FIG. 25 is a magnitude spectrum of an array of four QCM sensor elements held in a fixture in air.

FIG. 26 is a magnitude spectrum of an array of four QCM sensor elements held in a fixture, with one side submerged in contact with water.

FIG. 27 is a magnitude spectrum of a frequency encoded 21-element tuning fork sensor array.

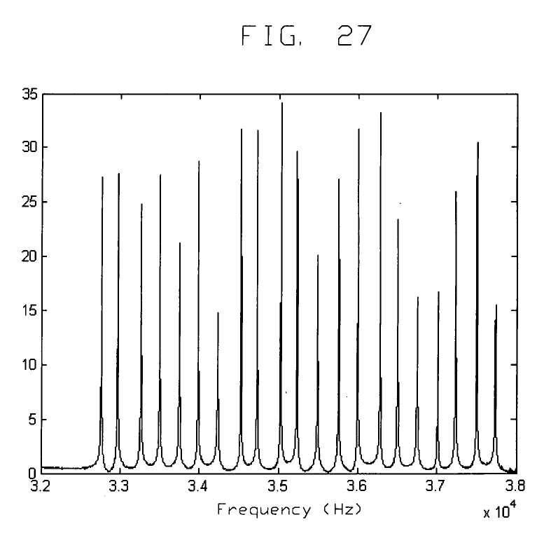

FIG. 28 is a diagram of an N-element sensor array comprising individual oscillator devices, with acquisition of the combined signal from the elements.

### DETAILED DESCRIPTION

System Overview:

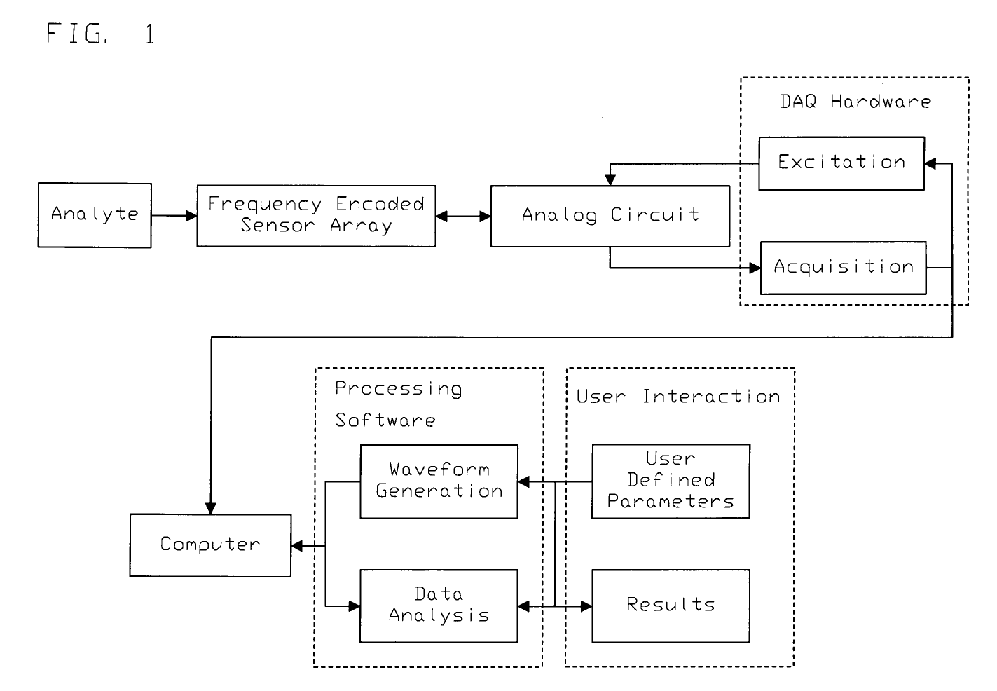

An overview of a typical sensor array system of this invention is illustrated in FIG. 1. As shown, analyte is exposed to a frequency encoded resonant sensor array. The analyte may comprise one sample or more than one sample of vapor, liquid, or in some cases solid material, and may comprise single or multiple components. The array comprises more than one resonant sensor element. The sensor elements in the array may be individually fabricated resonant devices, or they may be resonant structures fabricated into a monolithic substrate or a single device. The array is connected electrically to an analog circuit that serves as means for excitation of the sensor elements. In preferred embodiments, multiple sensor elements of the array communicate through a common electrical or data channel with the excitation and the acquisition hardware. The DAQ hardware may comprise stand-alone hardware, or may comprise DAQ hardware contained within another computing device. The DAQ hardware interacts with processing functions including spectrum analysis functions, other data analysis functions, and waveform generation functions, typically within a computer, but which may also be within custom hardware designed for handheld, stand-alone, or networked functioning of the sensor array. The processing and data analysis functions and the waveform generation functions interact with user-defined parameter, and provide results to the user regarding analyte attributes. The systems of this invention are generally useful for classification, identification, and/or quantification of analytes, depending on the particular application, the particular hardware configuration used, and the user needs.

Applications of the Invention:

The arrays and methods of this invention are useful for several important sensing applications. A first important application aims to classify, identify, or quantify analyte chemical vapors in an environment. Specific application environments include general environmental monitoring in buildings, atmospheric monitoring or testing of exterior environments, automotive applications such as fuel leak detection, medical applications such as breath analysis, and security application such as explosives detection or chemical weapons detection. For such applications, so called “electronic nose” (EN) or “cross-reactive sensor array” devices have been proposed. Typical EN devices are based on arrays of sensor elements with different but overlapping sensitivities to the presence of various vapor analytes. Devices that use a similar approach for the analysis of liquid samples are called “electronic tongues.” Because the various sensor elements of the cross-reactive array all respond to a variety of analyte stimuli, they can detect, and in many cases classify analytes that were not anticipated in the design or the sensor, much like human olfactory response provides useful information about new, unknown stimuli. In the present invention, embodiments for this application include frequency encoded resonant sensor arrays in which each of the sensor elements is coated with a unique sensing layer, and the entire array is exposed to a common analyte environment.

A second application important application for which the methods and arrays of the invention apply is the analysis of large numbers of analyte samples. In a typical sensor array of the invention for these applications, multiple sensor elements in an array are encoded to unique frequencies, but individual sensor elements or subgroups of elements comprise identical sensing layers. Each sensor element or subgroup or elements in the array is exposed to unique analyte environments. Such situations are common in the fields of combinatorial chemistry, high-throughput screening, drug discovery, process monitoring, chemical imaging and quality control. The resonance signals from each sensor element or subgroup are identified because of frequency encoding, and because the location of the elements is known, analyte-induced changes in the resonance signals are associated with a particular environment or location being measured. Frequency shifts or other spectral changes associated with the resonance signals from individual sensor elements can be analyzed to assess sensor response to analytes of interest.

A third important application area of this invention is the sensing of aqueous and biological analytes. Individual QCM sensors have been used in many biological applications, such as detection of microbial pathogens (Vaughan, 2003), blood type determination (Wegener, 2001), cell growth monitoring (Wegener, 2001), probing protein-protein interactions (Hauck, 2002), and many others. QCM sensors have the immediate attraction over many other methods that they measure mass directly, and so they are often best suited for detecting larger entities such as cells, microbes, and biomacromolecules, where techniques such as chromatography and mass spectrometry are most problematic. Acquiring data from QCM sensors in contact with aqueous solutions, a necessary condition for most biological applications of the sensor, requires specialized electronics for the analog circuit in connection with the sensor elements. The motional resistance increases or the quality factor deceases drastically when the sensor surface is brought in contact with a liquid due to viscous dragging. High gain electronics with an automatic level control (ALC) circuit is needed in order to maintain the oscillation (Wessendorf, 2001). However, the present invention provides many significant advantages over previous methods for sensing aqueous biological analytes. Frequency encoding an array of sensor elements and detection of the elements with a single electronic channel allows all of the sensor element electrodes in contact with the aqueous sample to be maintained at zero voltage relative to ground and the sample, eliminating otherwise debilitating interference between multiple sensor elements and electrochemical interactions with the sample. Also, the sensor elements of the invention are very stable over long periods of time, allowing the monitoring of biological processes, including cell growth or deposition, protein binding, nucleic acid hybridization, and other slow processes.

The arrays and methods of the invention offer significant advantages for analytes that are mixtures, single components, analytes that have high volatility or low volatility, analytes that are present in high concentration or low concentration, analytes from vapor, liquid, solid or other physical forms, or analytes from samples with extensive sample preparation or limited sample preparation. The frequency encoding method of this invention is not limited to any one application area Applications other than those specifically described here will be apparent to those skilled in the art.

Resonant Devices:

Many resonant devices are suitable for use as devices in the frequency encoded arrays and methods of this invention. Devices may be individually fabricated or fabricated in arrays. Suitable devices can be fabricated from many different materials, and they can function using many different physical principles. Particularly preferred devices include piezoelectric resonant devices prepared from piezoelectric ceramics or crystals. Examples of such preferred devices include piezoelectric or quartz tuning forks, TSM or QCM devices, and surface acoustic wave (SAW) devices. These piezoelectric devices have the advantages of simplicity, in that they are electrically actuated and provide a direct electrical signal for data acquisition. However, other devices, actuation methods, and data acquisition methods may also be used with the methods of this invention. For example, cantilever beams, torsion devices, and other geometries of resonant devices may be employed. Actuation of the devices may be through acoustic pulse actuation, optical or thermal actuation, actuation by direct physical contact, or observation of resonant signal from ambient motion of resonant devices, among other mechanisms. Although data acquisition is most preferably carried out using a direct electrical connection, such as the analog circuit of FIG. 1, data can also be acquired using optical means to observe direct motion of the resonant device, acoustic means (i.e., listening to the resonance), or other suitable means adapted to the details of the sensor device design.

One particularly preferred embodiment is a sensor array comprising quartz tuning forks as sensor elements. Because of the commercial availability, excellent stability, and low cost of many commercially available single-crystal quartz tuning forks, it is frequently preferable to start with identical, individual tuning forks such as those described in the Examples. Typically these tuning forks have dimensions of a few milimeters, and operate in vacuum with high q-values and resonant frequencies somewhere in the range of 10-50 kHz. Such tuning forks can be coated with sensing layers responsive to vapor of liquid-phase analyte. The effects of mass loading and analyte absorption on a sensor element tuning fork structure are not generally simple. Because the tuning forks have complex shapes, the distribution of sensing layer mass can be complex, and the relationship between mass absorption of analyte and tuning fork resonance properties may not be simple. Also, analyte effects on sensing layer stiffness, viscous drag in the environment, and dielectric environment of the resonator further complicate the relationship. However, there is usually a strong, reproducible signal from small changes in analyte identity or composition. Because the forks typically operate at lower frequencies than QCM devices, simpler and less costly data acquisition apparatus can be used in many cases. And because they typically have high q-values and relatively long resonance decay times, they are compatible with straightforward pulse/acquisition procedures. And for specialized sensing applications, custom-fabricated tuning fork structures can be readily

Another particularly preferred embodiment is thickness shear mode (TSM) or quartz crystal microbalance (QCM) devices as sensor array elements. As with the tuning forks, many types of inexpensive, commercially available TSM devices are suitable for use in the sensor arrays of the invention. The devices typically operate at higher frequencies than the tuning forks, typically in the range of tens of megahertz, making them very sensitive to small mass loading from analyte absorption to the sensing layers of the invention. The physical principles relating analyte absorption to device frequency response are generally predictable, making detailed, theory-based interpretations of sensor response more practical than with tuning forks. Similarly, frequency encoding methods have an excellent theoretical basis for achieving targeted encoding schemes. Because such devices have high frequency and short ring times, particularly in air and with sensing layers applied, a particularly preferred operating mode is the rapid scan simultaneous excitation/acquisition. However, many other operating modes are possible. Because TSM devices are geometrically simple, fabricating custom devices or monolithic arrays with multiple resonant regions is very straightforward. Also, the simple planar surface geometry simplifies the application of sensing layers.

Frequency Encoding:

The preparation of frequency encoded resonant sensor arrays is central to the present invention. In principle, encoded resonant sensor arrays can be prepared by any means that results in multiple sensor elements of an array with unique, resolvable resonance frequencies.

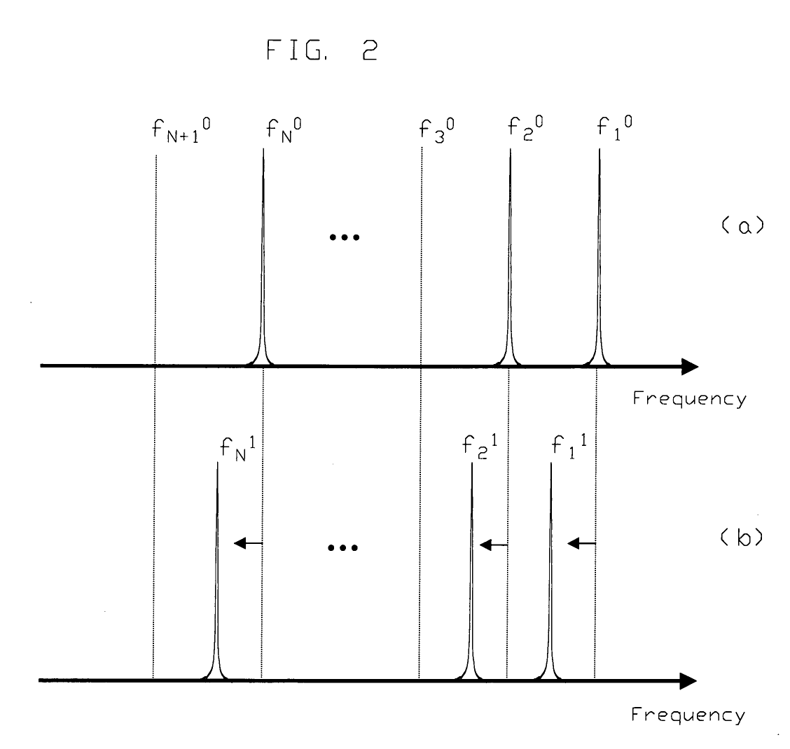

In preferred embodiments such as frequency encoded arrays for vapor sensing, it is generally the case that the frequency shift due to mass load caused by absorption of chemical vapors into the sensing layers is quite small, likely <<1% of the resonant frequency. With this in mind, it is possible to fabricate sensors with different resonant frequencies that utilize the available frequency spectral space while avoiding any signal overlap, considering mass loadings that will be encountered while operating the sensor within specified analyte conditions and concentrations. FIG. 2 illustrates one possible implementation scheme for frequency encoding an array of N sensor elements. Sensor #1 has the highest zero-load resonant frequency (f₁⁰and Sensor #N has the lowest zero-loading resonant frequency (f_{N}⁰). The zero-loading resonant frequency (fᵢ⁰) of Sensor #i is chosen so that at the highest mass loading expected under any analysis conditions its resonant frequency (fᵢ¹) signal will not overlap with it's neighbor's zero-loading resonant frequency (fᵢ₊₁⁰). If this conditions holds for all sensors (fᵢ¹>fᵢ₊₁⁰ for 1≦i<N), resolution of resonant signals for each sensor element will be possible for the sensor system in any given operating condition. The number of sensor elements that can be simultaneously resolved in a sensor array depends on a number of design factors, including the available bandwidth for sensor element actuation and data acquisition, the thickness and nature of the sensing layers, the q-values of the sensor elements.

Experimentally, it is common that the q-values for resonant sensor elements decrease when sensing layers are applied and when some analyte materials absorb in the sensing layer. This has been observed for tuning fork elements, and likely is related to dielectric effects of sensing layers and analytes. For TSM elements, sensing layers are usually applied on one side, and the observed decrease in q-value appears to be due to mechanical effects. The decrease in the q-value broadens the resonant curves, so that more spectral space must be reserved to prevent interference of the neighboring peaks in practical encoded array designs. Also, the design protocol described above considers only fundamental frequencies of the sensor elements. In practice, the highest zero-load resonant frequency (f₁⁰) should generally be smaller than the second harmonic frequency of sensor N that has the lowest zero-loading fundamental resonant frequency (f_{N}⁰). For many resonant device types, such as tuning fork resonators, the higher harmonic frequencies can be calculated.

General considerations for designing frequency encoded TSM sensor arrays are described in the following paragraphs. The fundamental resonant frequency (f) of a TSM sensor is determined by Salt, 1987)
f=F₀/t Equation 2
in which F₀ is the frequency constant and t is the thickness of the sensor base material. For commonly used quartz AT-cut sensor, the frequency constant is 1660 kHz mm. Therefore, a 10 MHz device has a thickness of 0.166 mm assuming the electrodes have no mass. One straightforward way to generate an encoded TSM sensor array is to make an array of sensors with varied thickness in sensor base material. For chemical vapor sensing applications, one can also use variation in polymer coating for the frequency encoding, although this approach generally convolutes the analyte concentration response of a particular sensor with its encoded frequency.

A preferred method is to start with sensors with the same frequency and to deposit in a controllable fashion a thin film material on the active surface of the sensor element. This can be accomplished by deposition of a thin film material in gas phase by a variety of methods, such as chemical vapor deposition (CVD), laser ablation deposition, electron beam evaporation, and sputtering. The relationship between frequency shift (Δf in Hz) and mass loading on one side (Δm in kg/m2) is described by the Sauerbrey equation

$$Δ f = - \frac{1}{\sqrt{{c}_{m} {ρ}_{q}}} {f}_{0}^{2} Δ m = - 1.13 \times {10}^{- 7} {f}_{0}^{2} Δ m \qquad Equation 3$$

in which cₘ=2.947×10¹⁰ N/m² is the effective elastic constant for AT-cut quartz crystal, ρ_{q}=2649 k/m³ is the density of quartz, and f₀ is the unloaded resonant frequency.

Physical vacuum deposition methods such as sputtering and electron beam deposition are used commercially to adjust frequencies of TSM devices used in frequency control applications. To frequency encode a TSM array, shadow masks can be used to control thickness of deposition on each element of the array. Other deposition methods include electrospray deposition, spray, spin coating, painting, dip coating, and electroless plating.

Electroplating offers a good control of the deposition process, under laboratory conditions and requiring little specialized instrumentation. One or both side of a TSM sensor can be plated when the cathode connecting the TSM electrode(s) is immersed in an electrolyte solution containing an ionic form of a metal. The counter anode consists of the pure metal or inert metals such as platinum as in the case of gold plating. When a current is allowed to flow through the system, the metal will be deposited on the electrodes of the sensor. The amount or thickness of coating can be calculated by the charge flowing through the system (integration of current with respect to time). If the plating is conducted with a constant current, the thickness of coating is proportional to the coating time. By electroplating for different times, sensors originally having the same frequency will become frequency encoded with unique resonant frequencies. It is often preferred to deposit the same metal as that of electrodes of the sensor.

For electroplating of a rigid metal film at constant plating current (I in A), the time (T in s) required to achieve a metal coating thickness (tₘ in m) is described by

$$T = \frac{q}{I} = \frac{{t}_{m} \times {ρ}_{m} \times F \times {n}_{e}}{J \times {MW}_{m}} \qquad Equation 4$$

in which q is the charge and I is the current. ρₘ in kg/m³ is the density of the metal, F=96485 C/mol is the Faraday constant, nₑ is the number of electron to reduce one metal atom, J in A/m² is the current density, MWₘ in kg/mol is the molecular weight of the metal. The frequency shift is related to the thickness of film deposited on one side by
Δf=−1.13×10⁻⁷f₀²×ρₘ×tₘ Equation 5

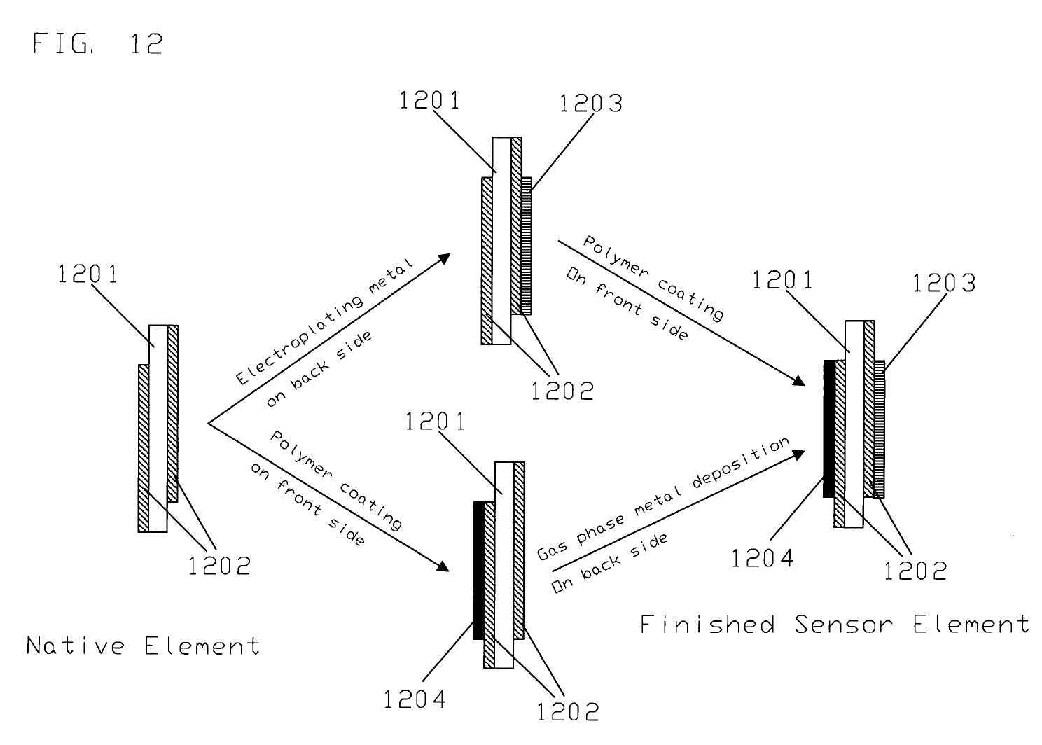

FIG. 12 illustrates two frequency encoding schemes for TSM sensor elements. In the first scheme, one side of the native sensor devices is first electroplated with metal of various thicknesses to frequency encode the array. Sensing layers, such as polymer coatings, are then applied to the encoded device elements. If similar sensing layers of similar mass are added, the frequency encoding scheme will be preserved, producing a uniform frequency shift due to coating. In the other scheme, sensing layers are first applied to one side of the native sensor elements. The other side is then coated with metal so that the final sensor will have the desired frequency. This scheme allows for carefully targeted sensor element frequencies, by monitoring frequency during the metal deposition.

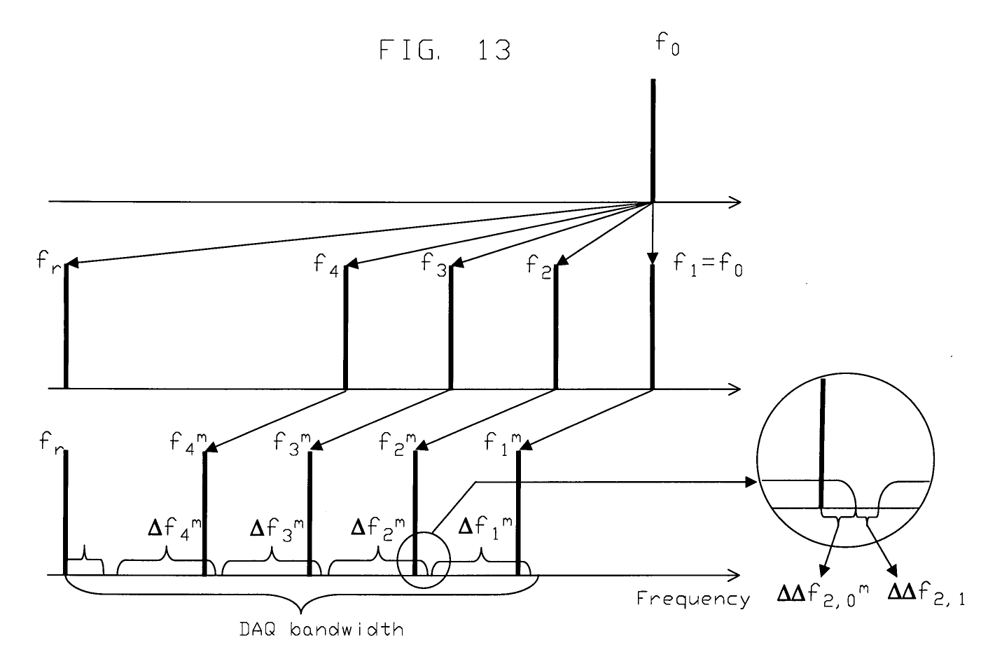

Illustrated in FIG. 13 is a frequency encoding scheme for a heterodyne detected TSM sensor array with four elements and a reference element, prepared by a process representative of that outlined in FIG. 12. In order to assure non-overlapping sensor elements signals, there are many frequencies and frequency durations to be considered. If a four-sensor frequency encoded array to be fabricated, one should start with five native devices with the same frequencies(f₀). The fifth one will be used as a source of frequency reference for heterodyne operation. A metal deposition process separates frequencies among the five devices (fᵣ, f_{4, f}₃, f₂, and f₁=f₀). The device with fᵣ will be used as the local oscillator for reference frequency. After applying sensing layers comprising polymer coatings, the frequencies of the four devices become (f₄^{m}, f₃^{m}, f₂^{m}, and f₁^{m}). This frequency encoding scheme considers possible frequency changes (Δf₄^{m}, Δf₃^{m}, Δf₂^{m}, and Δf₁^{m}) in all likely operating conditions. This also include possible negative frequency shift due to solvent extraction (ΔΔf_{i,0}^{m}, i=1-4, see insert in FIG. 13). Additional considerations include the signal peak width of the sensor elements. In preferred schemes, there should be enough frequency spacing between adjacent peaks at their closest approach, so that the resonance signal from each element can be unambiguously identified. Therefore a frequency gap is added between ranges of frequency changes (ΔΔf_{i+1,i}, i=1-4). After the above considerations, frequency differences (f₃^{m}-f₄^{m}, f₂^{m}-f₃^{m}, and f₂^{m}-f₁^{m}) are determined. The gap fᵣ-f₄^{m} is determined while considering additional information regarding the lowest practical frequency for data acquisition. From required coating thicknesses and the frequency of the virgin device (f₀), (fᵣ, f₄, f₃, and f₂) can be determined. In general, decreasing the thickness of the analyte-sensing layer on each sensor will decrease the frequency shift signal from each sensor. Although this typically reduces the precision of the sensor element signal or the sensitivity toward low analyte concentration, this also allows for smaller frequency gaps between elements, enabling the use of arrays with more sensor elements, useful for detecting complex analytes.

Although this disclosure describes several schemes for preparing frequency encoded arrays and several methods for using such arrays to measure analytes of interest, those skilled in the art can envision yet other encoding schemes and methods for their use, within the scope of the invention. As illustrated above, different encoding schemes may be optimal for different sensing layer materials, different sensing layer thicknesses, different sensor device types, geometries or frequencies, and for analytes under different conditions and for different applications. In some applications, preprocessing of the resonant signal from the sensor array may identify and isolate the resonant signal from each sensor element, possibly performing significant data reduction (i.e., identification of peak frequency, peak integral, and or peak width for each element) before calculating analyte measurements. In such schemes, it is essential that each sensor element's signal be uniquely and unambiguously identified, so that an encoding scheme should ensure that no overlap of sensor element signals occurs. In other applications, such as sensor arrays with many elements, the calculation of analyte measurement may simply and discard signals from sensor elements that inadvertently overlap under certain analysis conditions, so that encoding schemes may function well with sensor elements more closely spaced. In other applications, individual sensor element signals may be continuously tracked as they shift in response to analyte, so that the signals can be identified even though they may exchange relative frequency positions within the array. In yet other applications, the calculation of analytes measurements may not include any discrete association of a particular part of the frequency spectrum with a particular sensor element, but instead may rely on some complex calculation of the entire spectrum. Frequency encoded arrays will provide much better determination of analyte for such an application, compared to non-encoded sensor arrays, because of the intrinsic spread of signals that is likely to be measured. However, overlap or crossing of adjacent sensor element signals is accommodated, so that a useful frequency encoding scheme need not necessarily confine individual sensor element signals to specific frequency windows.

Sensing Layers:

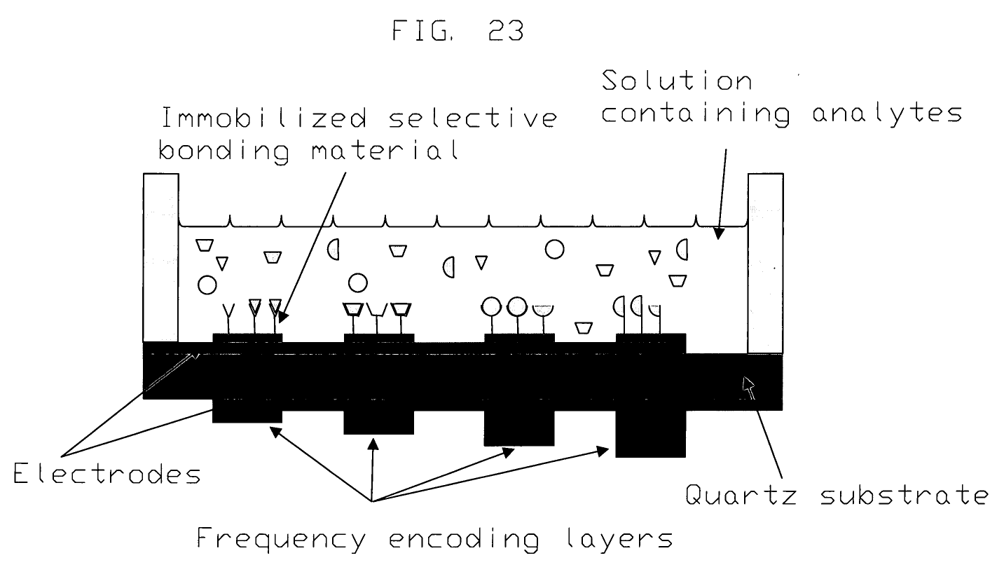

The frequency encoded sensor array elements of the invention have sensing layers applied to the resonant surfaces of the elements. For mass-sensitive resonant sensor elements, it is generally preferable or necessary to have the sensing layer mechanically coupled to the moving resonant surfaces of the devices. In particularly preferred embodiments, the sensing layers comprise organic polymer coatings. Polymeric coatings can have well-defined physical and chemical properties that are well suited to particular sensing applications. For example, “electronic nose” (EN) sensor arrays designed for the analysis of organic vapors may use a range of polymer films on different sensor elements, where the polymers differ in chemical composition, polarity, molecular weight, functional groups present, free volume, solubility, cross-linking, stiffness, glass transition temperature, crystallinity, fillers, microstructure, or other attributes that may influence the interaction of analyte with the polymer film Polymers frequently have desirable attributes of strength, toughness, coatability, layer uniformity, and solubility, that are well suited to forming well-defined sensing layers on the surfaces of the encoded sensor elements. Polymers or other sensing layers can be applied to the sensor from solution, from emulsion, from suspension, by lamination, by extrusion, by contact printing, by spraying, by vapor deposition, by dip coating, by web coating, or by direct polymerization or curing on the surface of the sensor elements, or by yet other means. Polymeric sensing layers may vary in thickness. In some applications, such as binding of biological analytes, thin sensing layers such as covalently bound polymeric monolayers may be sufficient, with thicknesses ranging from a few nanometers to a few hundred nanometers. Such layers can contain sufficient surface functionality to bind analytes of interest, including proteins, nucleic acids, or other biological structures of interest such as vesicles, viruses, microorganisms, or cells (see FIG. 23). In many preferred cases, thicker polymer layers are preferred, in the range of a few hundred nanometers to about a millimeter. Sensors with thicker coatings have higher sensitivity. The trade-off is a slower response to concentration changes. Organic polymer coatings of a few microns thickness are useful for many organic vapor sensing applications, where absorption of vapor into the thicker film provides sufficient resonance signal change associated with analyte absorption.

In many applications, reversible interaction of analyte with the sensing layers is desired, so that the sensor array can be used repeatedly or over long periods of time without changing its sensing attributes. However, for some applications, irreversible interaction of analyte with the sensing layer may be desirable. Such sensors can act effectively as “dose meters” for various analytes. Such irreversible interactions can be strong non-covalent binding, such as nucleic acid hybridization, strong host-guest interactions, or the formation of ionic or covalent bonds between analyte and functional groups in the sensing layer.

The sensing layers may comprise organic polymer coatings. They may also comprise other organic or inorganic materials, tissues, cells, or other analyte-sensitive materials. For example, and sensing layer for hydrogen gas can comprise a metal or alloy film into which hydrogen can reversibly dissolve. Similarly, metal coatings can act as irreversible sensing layers for oxidants such as oxygen or halogens. Quartz, silica, or other oxides can act as sensors for reactive silane compounds that bind on their surface. The sensing layers may be oils, glasses, crystalline compounds, composite materials, foams, clathrates, zeolites, or other forms. The sensing layers may be in the form of uniform or non-uniform coatings, patches, layers, inclusions, or other physical forms.

Sensor Array Configurations and Data Acquisition Methods:

A significant advantage of the invention is that the sensor elements of an encoded array may be combined into an array with a single excitation and detection channel. This is in contrast to most previous uses of resonant mass sensor elements as sensor arrays, where a typical configuration requires individual excitation and/or data acquisition channels for each sensor element, involving slow detection, expensive and complex detection hardware and software, and signal switching systems to focus excitation and/or data acquisition on a specific sensor element. In a typical sensor or sensor array of the invention where the elements have sufficient ring time and high stability, pulsed excitation of the array followed by acquisition of time-domain resonant signal from the array may be possible. This is analogous to common pulsed ¹H FTNMR techniques in which a broad excitation pulse is applied, followed by acquisition of time-domain free induction decay signal of all resonant species in the sample. Typically, a single channel for excitation drives resonance of all sensor elements, and a single data acquisition channel carries the output data stream for all of the sensors. In some cases, the input and output channels are identical.

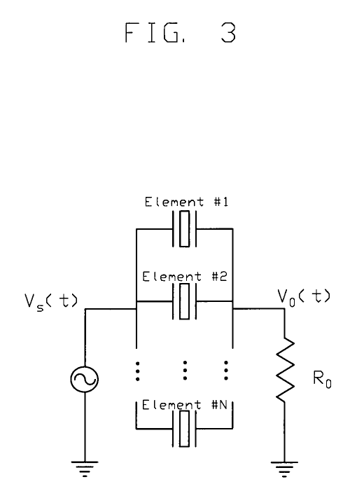

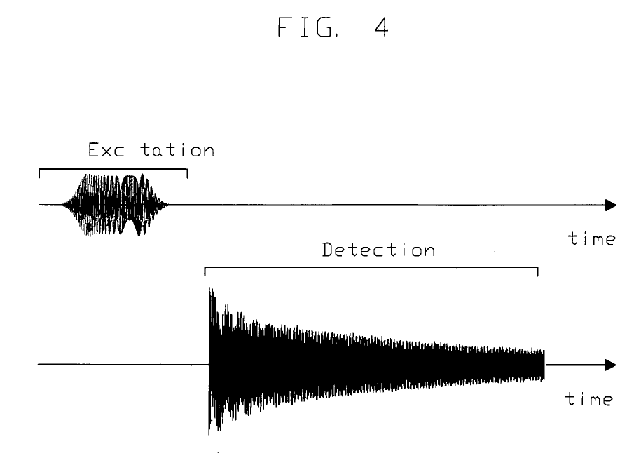

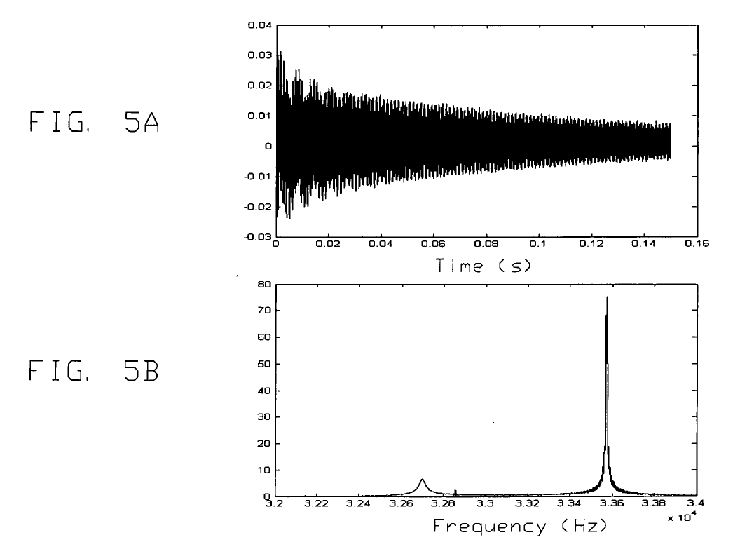

Due to the high Q-value and high stability of piezoelectric tuning forks such as quartz tuning forks, an attractive excitation/detection mode is the pulsed excitation of the entire frequency encoded array followed by acquisition of time domain data from the free oscillatory decay (i.e., the ringing) of the entire encoded array (See FIGS. 4-5). While many excitation waveforms can be used, a particularly preferred embodiment of the method is the application of a SWIFT (Stored Wave Inverse Fourier Transform) waveform. (Guan and Marshall, 1996) SWIFT excitation can offer significant advantages over other excitation methods, such as frequency sweep or chirp excitation. As shown in FIG. 3, a typical encoded tuning fork sensor array is formed by connecting N sensors in parallel. Such sensor configuration works well at low resonant frequency and for devices having low shunt capacitance, as in the case for tuning forks. In this case, high-q or well-localized mechanical equivalent circuit dominates the electronic behavior and little cross-talk results.

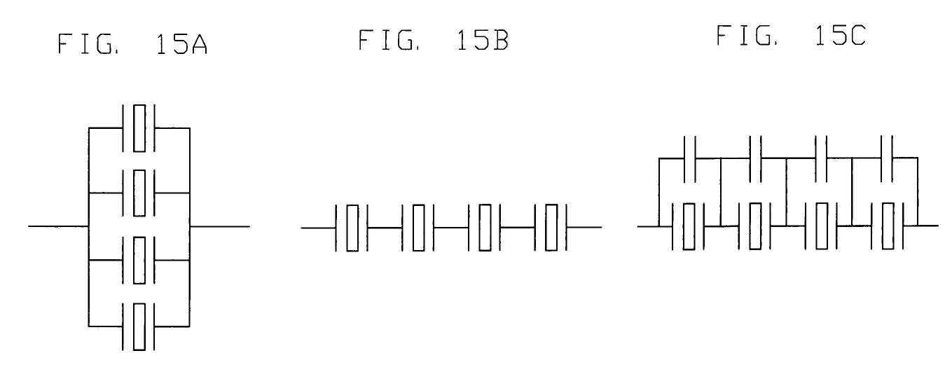

In a typical sensor or sensor array of the invention where the pulsed excitation/detection method is difficult to realize because of short free oscillation decay times or because short and high amplitude excitation pulses are required, a rapid scan Fourier transform method in a direct or heterodyne configuration is generally more appropriate. FIG. 15A-15C show three options for connecting various sensor elements of an encoded TSM sensor array. The rapid scan approach retains simplicity of hardware with a common detection channel, while preserving near simultaneous detection of each sensor element. For higher frequency devices, including SAW and TSM arrays, matching networks are typically required to reduce shunt capacitance. The excitation source is connected to one end of the sensor array and the other end is connected to the electrical ground through a resistor and to the acquisition preamplifier. In an ideal situation, the output impedance of the excitation amplifier should be infinitely small and the input impedance of the preamplifier should be infinitely large.

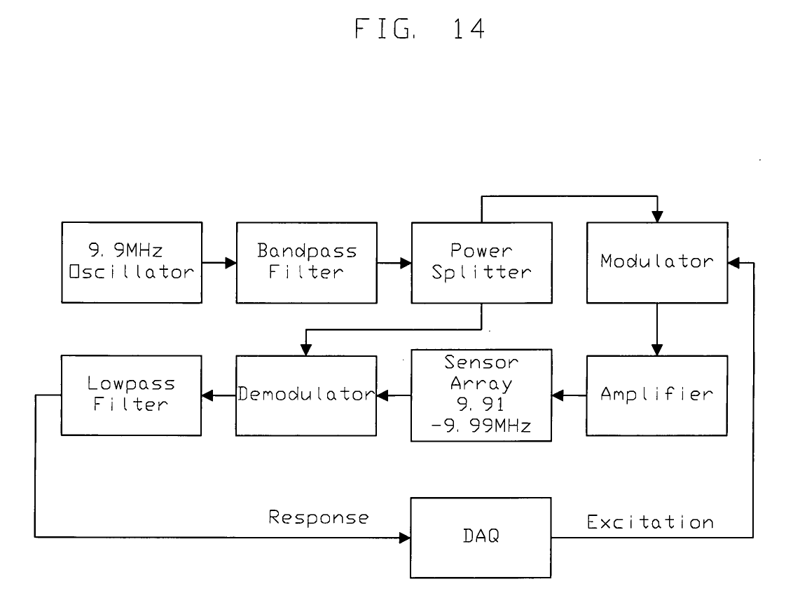

A typical TSM device resonates at several to tens of megahertz (MHz) (say, 10 MHz) and a typical frequency shift due to situated absorption of chemical vapors on a 2-micron polymer film is about ten kilohertz (kHz). For a 10-sensor element array, the detection frequency range is on the order of hundreds of kHz (say 200 kHz). With the limited bandwidth of the array resonance, it is not necessary to provide high-frequency data acquisition hardware that can digitize data in a direct mode at above twice of the resonant frequency of the sensor with the highest resonant frequency in the array, in this example requiring greater than about 20 MHz sampling rate. Rather, one can digitize data in a heterodyne mode with a reference frequency close to the resonant frequencies of the array sensor elements. This mode requires simpler and less expensive data acquisition hardware, with a maximum sampling or digitizing rate only twice that of the detection frequency range (i.e., 400 kHz). A block diagram of an analog circuit to enable this heterodyne detection system for a frequency encoded TSM sensor array is shown in FIG. 14. For example, a local oscillator based on a 9.9 MHz TSM device is used, prepared from a virgin 10.000 MHz device by the frequency encoding method described above. The local oscillation signal runs through a bandpass filter to clean up higher harmonics and low frequency noises before being split into two equal level sources. One source is fed into a double balanced modulator whose modulation source is the excitation signal generated by a computer DAQ system. Ideally, a single-side band (SSB) I&Q modulator should be used for frequency mixing. The modulated signal is amplified before being fed to one port of the sensor array lumped as a two-port device. The other port is connected to a demodulator together with the other reference source. The demodulated signal is subjected to a low pass filter and is then digitized.

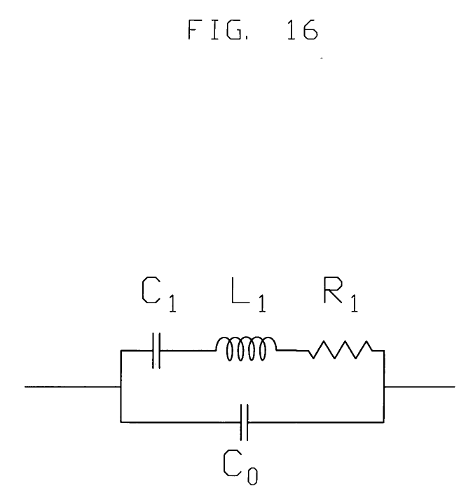

Precise characterization and impedance matching of a TSM resonator is an involved engineering task. A review in the field can be found in (Gerber, 1985). For the purpose of sensor array applications, generally the most important quantity to be measured is the resonant peak position (and hence the frequency shift due to analyte interaction) of each sensor element. For a low frequency tuning fork based sensor array, a large number of sensors can be connected in parallel to form a two-port equivalent device as shown in FIG. 15A This can be done since resonant frequencies for a typical tuning fork is quite low (i.e., around 20-40 kHz) and admittance by the shunt capacitance (C₀ in the equivalent circuit in FIG. 16) is quite small (Y₀=iωC₀). Due to the device element's small size, the shunt capacitance itself is also small. Signal shortage for both excitation and detection by the n parallel-connected shunt capacitance can be neglected. This effect cannot be neglected in the case of a TSM sensor array. First, the shunt capacitance for a typical TSM sensor is quite large due to its large electrode area. Its frequency is about three orders of magnitude higher. Therefore the direct parallel connection as shown in FIG. 15A may no longer practical. For a sensor array with a limited number of elements, a serial connect shown in FIG. 15B can be used. To more evenly distribute excitation power to each element, a capacitive ladder can be used (FIG. 15C).

After polymer coating, a typical quality factor of the frequency encoded TSM sensor element is about 10,000 in air. At a resonant frequency of 10 MHz, the free oscillation decay can only last a few milliseconds. It is possible to excite the mechanical oscillation and detect its free-excitation decay or free oscillation decay (FOD) before it decays into the noise level. However, this requires a short excitation period and therefore high excitation amplitude. The higher level excitation electronics will produce higher noise leakage into detection channel. A more economical and efficient method is application of longer (but still quite short compared to conventional frequency scanning) excitation waveform while detecting the signal simultaneously. The method is called rapid scan Fourier transform or correlation spectroscopy.

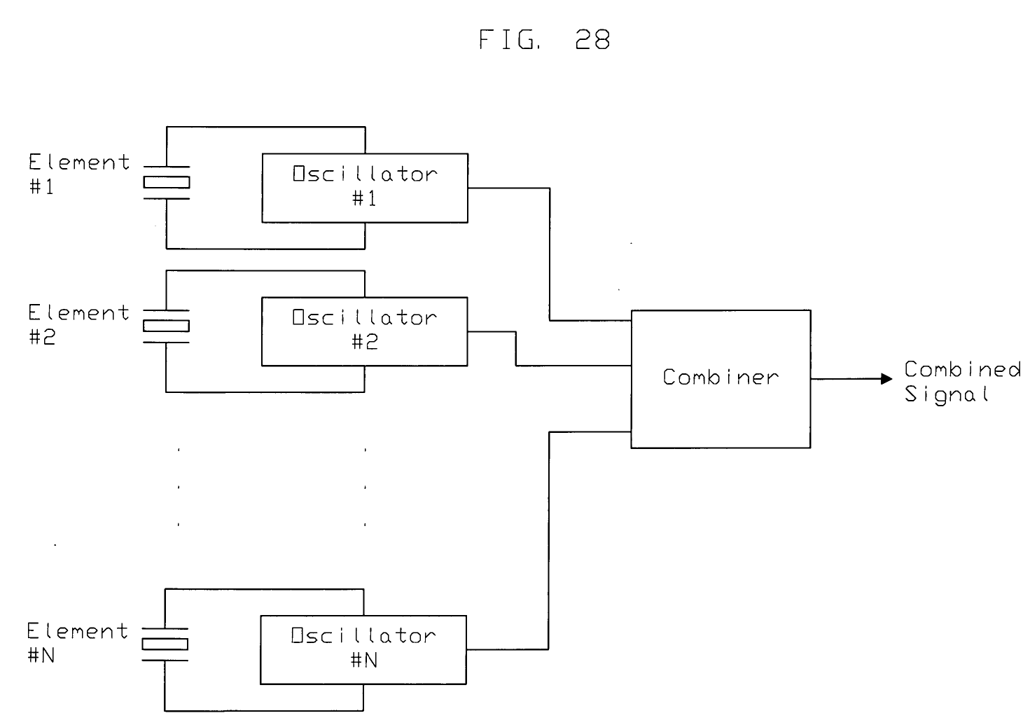

A frequency encoded sensor array can be configured as a group of individual oscillators, whose output can be combined into a detection signal channel, as shown in FIG. 28. The combined signal can be acquired and its frequency components can be resolved by converting the time domain data to frequency spectral data. The advantages of such a configuration comparing with excitation and detection schemes include that one can acquire an infinitely long time domain data to achieve infinitely high resolution, provided oscillators and their corresponding sensor elements are infinitely stable. The configuration does not give other information about resonances, such as peak width

While preferred modes of data acquisition involve acquisition of time domain followed by spectrum analysis, direct acquisition of a frequency spectrum from an encoded array can be carried out using typical slow frequency scanning methods. While simultaneous data from various sensor elements is not obtained this way, this approach is suitable for many applications.

Spectrum Analysis:

Frequency domain data is generated by performing spectral analysis, such as fast Fourier transform (FFT) analysis, which allow the frequency shift of each sensor element to be detected with high resolution and high precision. FFT methods also simplify detection electronics making the sensor system more affordable. By directly measuring time domain data, simultaneous measurement of all sensor elements is an inherent advantage. Also, techniques such as signal averaging and signal weighting allow for optimization of data acquisition and suppression of noise. As alternatives to FFT methods, one can apply advanced data reduction methods such as linear prediction (LP) and maximum entropy methods (MEM) for spectral analysis, further increasing the accuracy of frequency determination. Such methods generally require much more computational capacity than FFT methods.

With the encoded sensor arrays of the invention, one can distinguish frequency domain signals of individual sensor elements simply by detecting peaks in defined frequency ranges, or by identifying overall patterns of peaks. While significant information from each sensor element is obtained simply from precise peak frequency positions, additional information is obtained from peak shapes, integrals, and other analyses. Although a conventional frequency scanning method can be used to construct the spectral response of the sensor array, it is often more effective to apply a Fourier transform spectrum analysis method, particularly for pulsed or rapid scan data acquisition methods for time domain data in which all frequencies are detected simultaneously or near simultaneously. In this way, data acquisition transients can also be accumulated or coadded to increase the signal-to-noise ratio, and zero filling can be carried out before transformation to increase digital resolution. Also, various weighting schemes can be applied to the time domain data, if appropriate. These include elimination of early data points that may carry over signal from pulsed excitation, and exponential multiplication or other weighting curve functions that emphasize higher quality data in certain regions of the time domain data.

Data Analysis and Analyte Determination:

The purpose of data analysis for a sensor array is to convert raw data, such as frequency shift data due to absorption of analyte, into desired results, such as classification, identification, or quantification of analyte. “cross reactive” sensor systems rely on differentiation of analytes by their differential absorption onto sensing layers of different sensor elements. The absolute differences in absorption of each analyte into each sensing layer are typically not very large. The power of differentiation comes from the accumulation of these modest absorption differences over many sensor elements. There can be many different data analysis methods for sensor systems of the present invention. Raw time domain data of calibrant samples directly acquired by hardware or frequency spectral data can be used to train multivariate procedures. Frequency shift and/or resonant parameters such as peak width and peak distortion can be used by a nonlinear analysis programs to derive the results. One can also treat the data according to physical principles, as shown in the example. According to the Sauerbrey equation, the mass or concentration of analyte absorbed on a sensor element is proportional to the observed frequency shift. Since the partition coefficient is the ratio of concentration of analyte in gas phase and concentration in the absorbing sensing layer, one can linearize the relationship between sensor element data and vapor component concentration. Once the data are prepared in such a linear fashion, they can then be subjected to a linear analysis method such as principal component analysis (PCA).

Different applications for sensor systems of the present invention require different data analysis methods. The objective of analysis by electronic noses (EN) is to classify and/or identify analyte. For this purpose, qualitative analysis methods are most suitable. For many process control applications or combinatorial chemistry applications, particularly with large numbers of samples, the objective of analysis can often be quantification of particular analytes that are known and likely to be in the samples. Another consideration is that the aim of some analyses is the precise determination of static analyte mixtures, while other analyses monitor fluctuations in analyte over time, and yet other analyses aim to measure the cumulative exposure of the sensor to particular analytes. Therefore, some sensor elements and sensing layers can be designed for slow but sensitive absorption of analytes, others for rapid and reversible absorption of analytes, and yet others for irreversible binding of analytes.

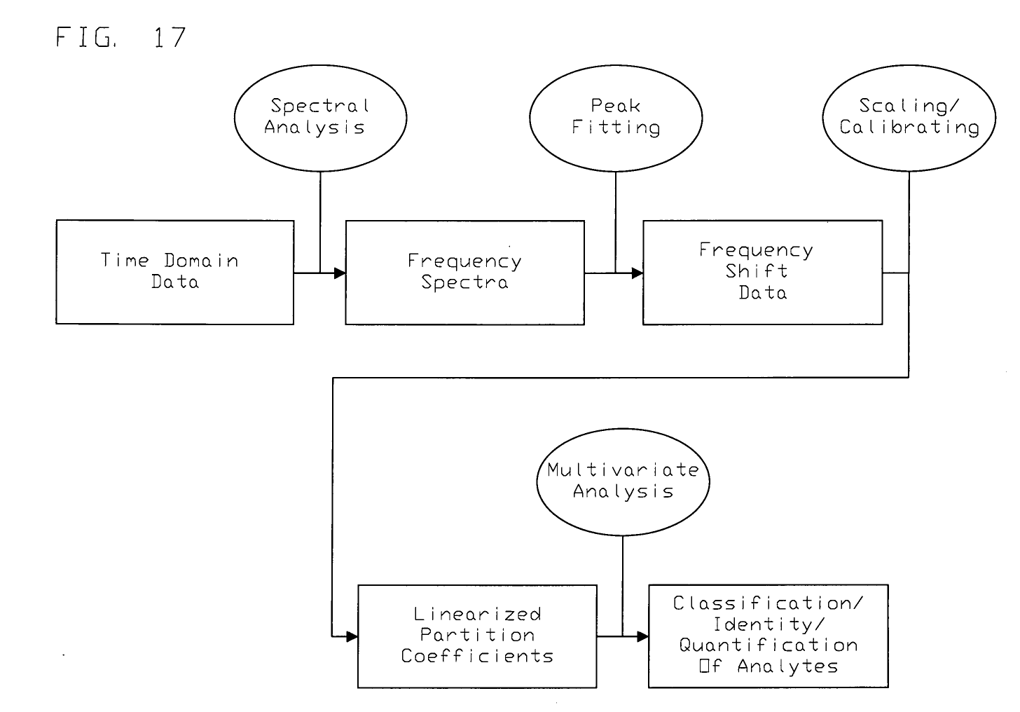

One preferred data processing flow is illustrated in FIG. 17.

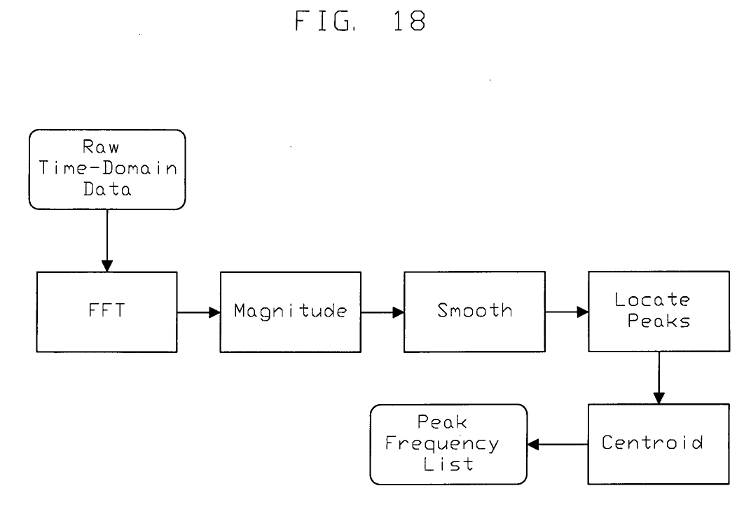

Generation of peak locations. Any raw time domain data either acquired from free oscillation decay in the pulse excite/detect experiment or from response of the sensor array during excitation in the rapid scan mode is first transformed into frequency domain by a spectral analysis method, as described above. For data acquired during excitation, it is often necessary to de-phase and remove un-uniformity from the magnitude spectrum before further processing (dividing the frequency domain spectrum by the spectrum of the excitation waveform). After the frequency domain data is obtained, a peak finding procedure is performed to generate a list of parameters to describe peaks. Such parameters include peak location (frequency), peak width, skew level, and others. To effectively characterize the peaks, a theoretical model for the peaks needs to be established. For free decay of a harmonic oscillator that has a friction force proportional to the motional velocity, the spectral peak can be described by a Lorentzian. If many uncorrelated forces are presented, the peak may be a Gaussian. The validity of the theoretical model should be proved by detailed theoretical and experimental studies. Fitting many peaks with a complicated functional form is both computationally intensive and subject to significant potential errors that are difficult to eliminate. For many applications, one parameter for each sensor element such as peak frequency may be paramount, making simpler procedures available for processing. For example, fitting only the top portion of each peak with a parabolic function may be an effective method. As shown in FIG. 18, a centroid procedure can be used to generate a list of peak locations.

Preprocessing for Multivariate Analysis. The multivariate analysis methods for sensor arrays used for chemical vapor detection have been recently reviewed (Jurs, 2000). There are many multivariate analysis methods available. The most commonly used one is the principal component analysis (PCA). PCA typically requires linearization and normalization of sensor element responses. An example of PCA analysis for classification of various analyte vapors is described in Example 6. Other useful methods for treatment of sensor data may include statistical pattern analysis, linear calibration methods, linear discriminant analysis (LDA), cluster analysis (CA), other “intelligent” pattern analysis techniques such as artificial neural networks (ANNS), multi-layer perceptron (MLP), fuzzy inference systems (FIS), self-organizing maps (SOM), radial basis functions (RBF), genetic algorithms (GAS), neuro-fuzzy systems (NFS) and adaptive resonance theory (ART). Most of these methods are not described here in detail, but those skilled in the art will be able to apply appropriate analysis techniques for particular sensor array designs and analyte-sensing applications.

Materials. Solvents were all semiconductor grade (Lab-Pro, Sunnyvale, Calif.), used without further purification. PDMS was obtained from Dow Corning (SylGard 184) as a two-part kit. Paraffin wax was from Aldrich (mp 73-80° C.). Other polymers were obtained from Scientific Polymer Products, Inc. (Ontario, N.Y.). Quartz tuning forks were obtained from DigiKey (Thief River Falls, Minn.), and the devices were removed from the cans by cutting with a knife or rotary grinding wheel.

### EXAMPLE 1

### Fabrication of a Two-element Frequency Encoded Tuning Fork Sensor Array

Resonant frequencies of two commercial tuning forks were measured in air without coatings by the method described below. One device was coated with paraffing wax by dipping a tuning fork in a 5% wax solution in acetone, without frequency trimming. The tines of the other device were shortened by grinding on a diamond cutting wheel to increase the resonant frequency. After its resonant frequency was measured, the device was coated with PDMS by dipping into an approximately 5% PDMS solution in toluene. The PDMS solution was prepared by mixing 10:1 silicone elastomer base:curing agent in weight, and then adding 95% weight of toluene. The sensors were allowed to dry in air overnight.

The two sensors were connected in parallel and a 4.7 kΩ resistor was then connected in series before connection to a data acquisition card (NI6062, National Instrument, Austin, Tex.), interfaced to a laptop computer through a PCMCIA slot. A visual BASIC program was written to control SWIFT excitation and data acquisition.

SWIFT excitation waveforms were synthesized according. to the published algorithm (Guan, 1996). Briefly, a magnitude spectrum was specified from excitation in a frequency range of interest. In this case, a bandwidth of 3000 Hz centered at 32768 Hz was used to define the target magnitude spectrum. A smooth procedure was performed twice to reduce the power leakage of the final waveform to the ends of the excitation period. The corresponding phase spectrum was synthesized to reduce the dynamic range and to locate the excitation power to the central region of the excitation period. The final excitation waveform was obtained by inverse Fourier transform with the smoothed magnitude and phase spectra. The SWIFT waveform produces a uniform excitation power from 32768−1500 Hz to 32768+1500 Hz, allowing excitation of all sensors whose resonant frequencies are within the frequency range.

A total of 15000 data points were acquired at a rate of 100,000 samples per second. Ten acquisitions were coadded to achieve a better signal-to-noise ratio. Zeros were added to the end of the data series and FFT was performed to achieve a frequency sampling spacing of 1 Hz/data point. The quartz crystal tuning forks for timing applications are typically trimmed at factories to have a nominal resonant frequency of 32768 Hz in vacuum. In air, the frequency decreases due to the damming effect. Shown in FIG. 4A is the SWIFT excitation waveform and the corresponding time domain free oscillation decay (FOD) signal, 4B and 5A acquired from the two coated sensor elements in air. The SWIFT excitation ensures that all sensors are excitation to the same (oscillation or vibration) level (Guan, 1996). With the present electronics, the free oscillation decay signal for the PDMS coated sensor in air can still be observed above noise level 1.0 second after termination of excitation. Its magnitude spectrum in FIG. 5B contains two peaks corresponding to the two sensors. Peak locations were obtained by finding the highest point in the neighborhood of the peak in the magnitude spectrum. The first peak at 32700 Hz is due to the wax coated sensor. The coating thickness can be estimated from the frequency shift of resonant frequency from that of the uncoated to be 1.34 μm. The peak at 33573 Hz is due to the PDMS coated sensor with an estimated film thickness of 1.86 μm. Since the PDMS coated sensor has a resonant frequency in air 873 Hz higher than that of wax coated, the peaks are well resolved, with no expectation that they should ever overlap under any analysis conditions.

### EXAMPLE 2

### Vapor Component Detection Using a Two-element Tuning Fork Sensor Array

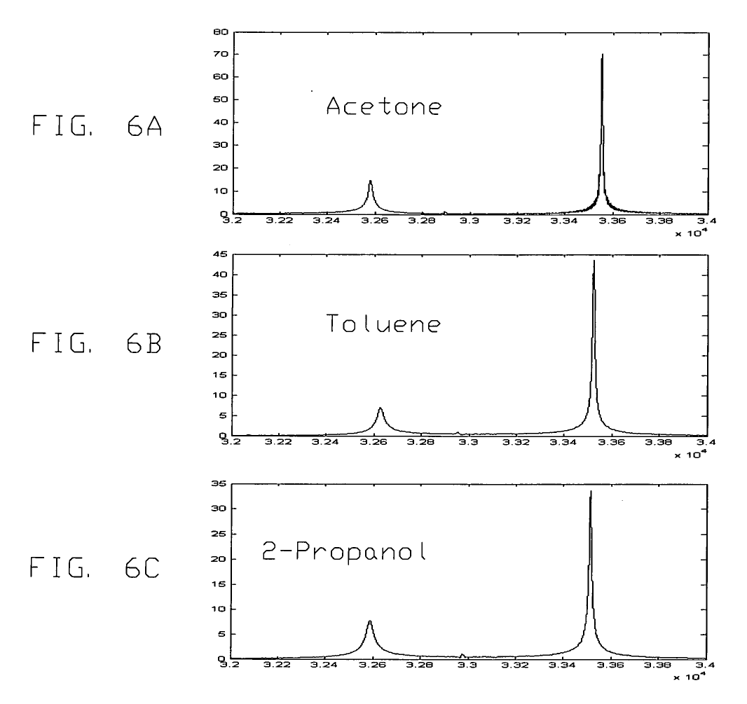

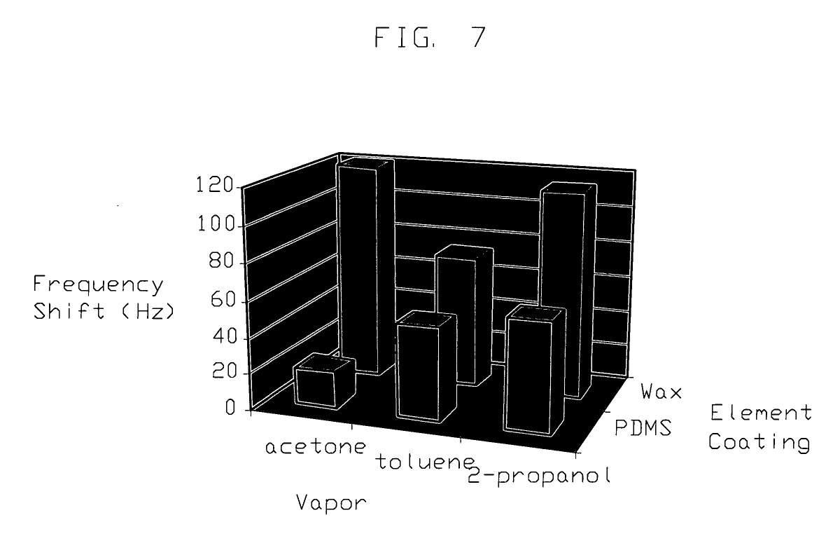

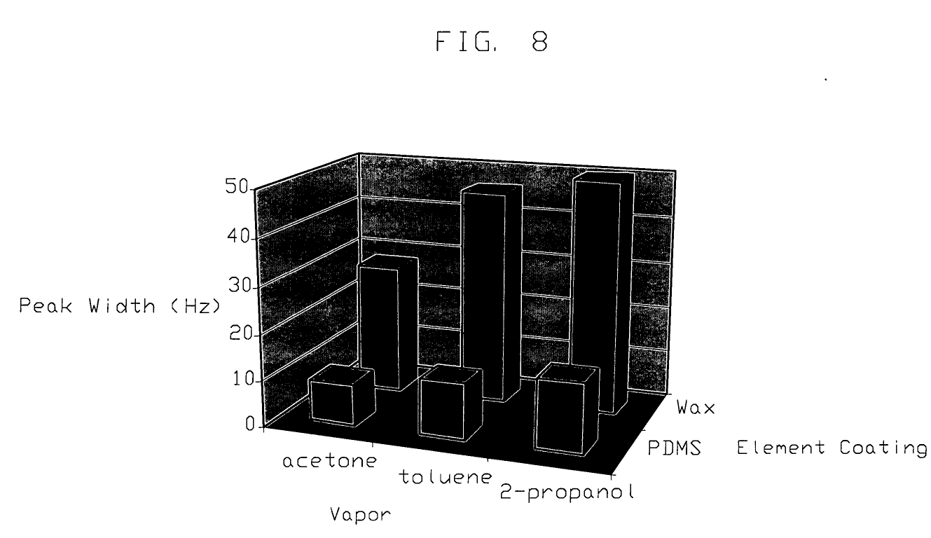

The vapor sensing was conducted using the sensor and data acquisition protocol described in Example 1, at 70° F. (21.1° C.). At this temperature, literature reported equilibrium vapor pressures for the solvents are: 2-propanol at 33.5 torr, toluene at 22.3 torr, and acetone at 170.1 torr. A small amount of one solvent was added to a 20 mL vial, sufficient to saturate the vapor, and the vial was allowed to equilibrate for 10 minutes. The sensor was brought into contact with the vapor in the vial and sensor data was acquired. The analyte-dependent response of the sensor was sufficiently fast and there was no observable change in resonance peak positions for the sensor elements in subsequent acquisitions after the initial measurement of the vapor environment. When the sensor was removed from the vapor, the sensor element frequencies returned to the initial values within 2-3 seconds. In this way, the response of the two-element sensor array toward saturated vapor of these three solvents was measured. FIGS. 6A through 6C show three magnitude spectra of the sensor exposed to three solvent vapors. All three types of vapor absorbed into the wax coating to a significant degree, as indicated by the frequency shifts shown graphically in FIG. 7. The q-value of the wax coated sensor element was lower than for the PDMS-coated element, perhaps caused by mechanical damping of the coating. Solvent absorption increased the q-value for the sensor element with the wax film comparing to the q-value observed in air. For the PDMS coated sensor, 2-propanol and toluene absorbed significantly, but there was less signal for absorption of acetone. FIG. 8 shows changes in the peak width of the three sensor elements in the presence of the three different vapor samples.

### EXAMPLE 3

### Fabrication and Vapor Sensing of a 9-element Tuning Fork Sensor Array

Using commercially available quartz tuning fork devices, as described in Example 1, a 9-element sensor array was prepared. Polymers used to fabricate the 9-sensor array were dissolved in THF at a concentration of 2-2.5%, and the forks were dip-coated in these solutions. Pulsed excitation followed by acquisition of the FOD signal was carried out as in Example 1. Peak locations for each sensor element in the 9-sensor array were calculated by a centroid procedure.

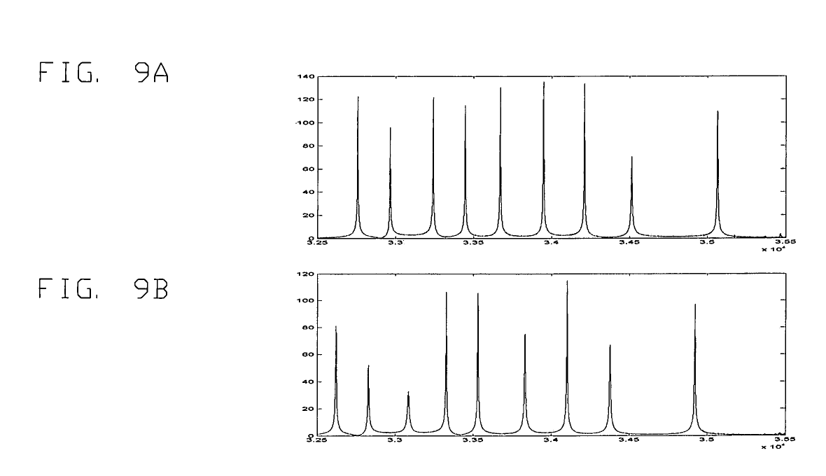

As shown in FIG. 9A, the frequency encoded 9-device array before polymer coating occupies a frequency range of 3 kHz (32.5-35.5 kHz). The uncoated sensors are roughly evenly distributed in the frequency range and have a similar q-value (peak width). Sensor #9 (numbered sequentially from low to high frequency) has low signal intensity, and possibly was damaged by the frequency shifting process. Polymer coating also causes a decrease in the q-values for many sensors, shown in FIG. 9B. The most apparent is Sensor #3, coated with ethyl cellulose. It is not known at this time whether mechanical or dielectric effects are primarily responsible for this effect. If necessary, tuning forks can be coated with a low dielectric film before the polymer coating. Polymers used for fabrication of a 9-sensor array, the final unloaded resonant frequencies, frequency shifts due to polymer coating, and the coating thickness are listed in Table 2. The choice of the polymers was based on chemical diversity within the samples available. FIG. 9 summarizes the results for experiments conducted on the nine sensor array exposed to three chemical vapors. Differences in responses by sensor elements in the array exposed to different vapors are apparent from visual inspection. Many suitable computational techniques are available to correlate such sensor responses with analyte attributes.

### EXAMPLE 4

### Fabrication of a Four-element Frequency Encoded TSM Sensor Array

10.000 MHz AT-cut TSM quartz crystal resonators were acquired (PN: XT50Q1H1) as manufactured by M-TRON Industries, Inc (Yankton, S.Dak.). The devices are packaged in a HC-49/U case with a load capacitance of 17 pF and a maximum equivalent series resistance (ESR) of 40 ohms. Advantages of using standard production microprocessor crystals as sensor devices include low cost and their well characterized electrical behavior. The cans were removed to expose the electrodes.

To generate frequency encoded sensor array elements, one of the electrode surfaces of each device was electroplated with a unique thickness of nickel. Nickel was chosen as the coating material because it is used as the electrode material in many commercial TSM crystals and it is relatively inert. The nickel electroplating solution contained the following components dissolved in distilled water:

| | |
|---|---|
| Nickel Sulfate | 200 g/L |
| Nickel Chloride | 5 g/L |
| Boric Acid | 25 g/L |
| Iron (II) sulfate | 8 g/L |
| Saccharin | 3 g/L |

Electroplating was performed first on one device used as a frequency reference for the heterodyne operation with a current density of 1 mA/cm². The final resonant frequency was measured to be 9.87 MHz, corresponding to a nickel film thickness of 1.29 μm on one electrode. Three other devices were electroplated to separate their resonant frequencies from the original value of 10.000 MHz. A virgin device was used among the three as frequency encoded array elements.

Data acquisition was carried out on a PCMCIA DAQ card (NI6062, National instruments, Austin, Tex.). The 9.89 MHz local oscillator was configured to generate a TTL level source signal. It was filtered by a bandpass filter (PBP-10.7, MiniCircuits, Branson, Mo.) before split into two outlets by a power splitter (PSC-2-1, MiniCircuits). One of the reference signals was modulated in a modulator (MIQA-10M, MiniCircuits) by excitation source from a DAC channel of the DAQ card. The modulated signal was amplified by a IF amplifier-based on (MC1350, Motorola). The amplified signal was applied to one end of the sensor array configured as shown in FIG. 4c. The capacitors in the ladder were 10 pF ceramic. Demodulation was done on (MIQA-10D,MiniCircuits) with the reference signal #2. The demodulated signal was filtered by a π-type low-pass filter with a cut-off frequency of 1.5 MHz and digitized at a rate of 250 kilosamples per second. Acquisition of 16000 data points over 64 milliseconds was carried out.

Calculation of the SWIFT excitation waveform (Guan, 1996) was performed with MatLab software (Math Works, Natick, Mass.). SWIFT excitation has a uniform excitation level from 10 kHz to 120 kHz, occupying 80% of central portion of excitation period. A total of 16000 data points were clocked out at 250 kilosamples/second, the same as that for data acquisition Spectral edges were smoothed to prevent the Gibbs's oscillation. Data acquisition software was written in Visual BASIC with hardware interface add-ons of Measurement Studio (National Instruments).

Polymers were obtained form Scientific Polymer Products, Inc. (Ontario, N.Y.). One of four different polymers was coated on one side of each of the four sensor elements. The following table lists the polymer and coating thickness:

| | | Density | Frequency | Coating |
|---|---|---|---|---|
| Sensor | Polymer | (g/cm³) | Shift (Hz) | Thickness (μm) |
| #1 | Poly(vinyl pyrrolidone) | 1 | 24073.38 | 2.13 |
| #2 | Poly(n-butyl | 1.04 | 24670.91 | 2.10 |
| | methacrylate) | | | |
| #3 | Poly(vinyl stearate) | 1 | 20868.05 | 1.85 |
| #4 | Polyethylene, | 1.25 | 21117.98 | 1.50 |
| | 48% chlorinated | | | |

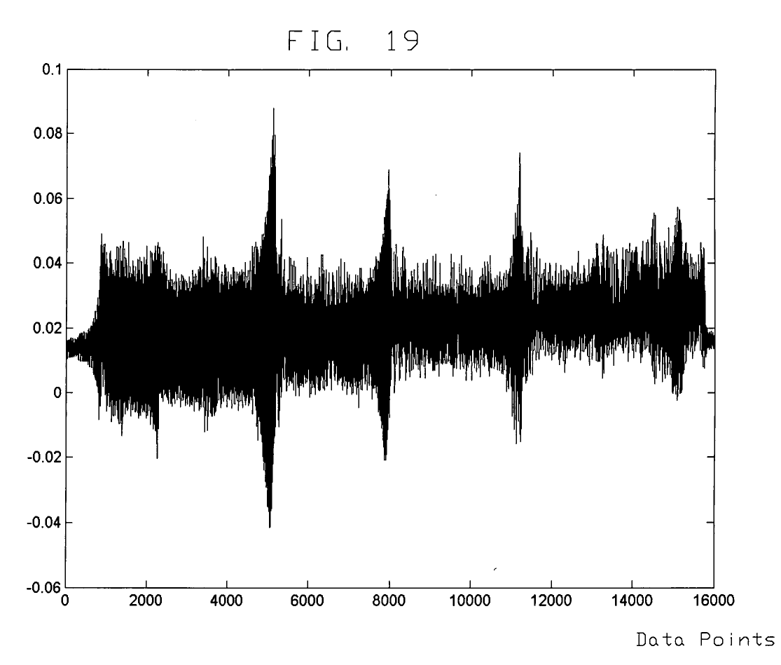

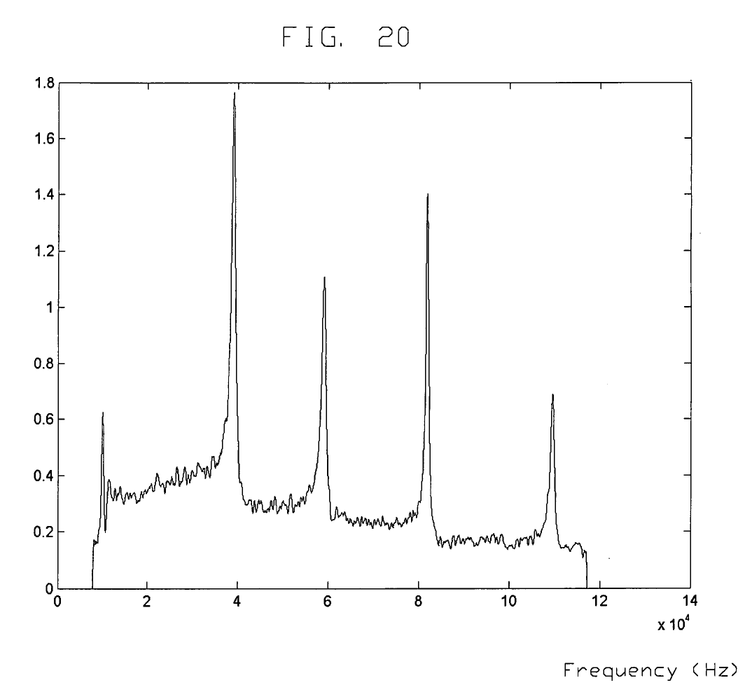

A time domain data acquisition for the four-sensor array expose to air acquired with no coadding is shown in FIG. 19 and the corresponding magnitude spectrum is shown in FIG. 20. The four peaks corresponding to the four sensors have different peak height and peak width. The peak width, related to the quality factor of the sensor, depends on type and thickness of polymer coating. For the four sensor elements, the q-value is about 10,000. The signal strength or the area under the peak is generally higher for thicker nickel coating devices. Since the q-value does not decrease with nickel plating, the increase in signal strength may be caused by increased motional amplitude with thick mass loading.

### EXAMPLE 5

### Vapor Component Detection Using a Four-element TSM Sensor Array

Approximate 1 μL of solvent corresponding to the vapor being detected was loaded into a 50-mL glass vial containing the four-sensor array described in Example 4. The sensor was tested with eight different vapors samples: toluene, water, 2-propanol, tetrahydrofuran (THF), xylenes, methanol, acetone, denatured alcohol.

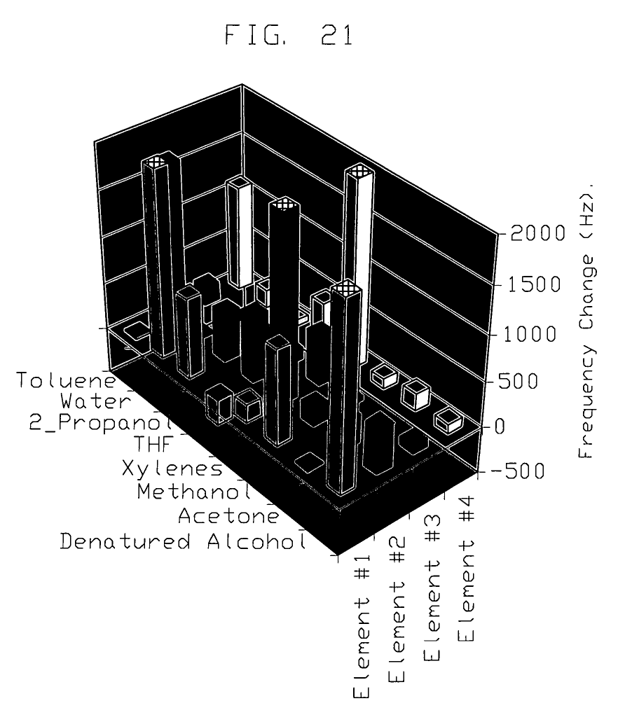

Data for the four-sensor array exposed to eight vapors were summarized in FIG. 21. Four data points are off scale and truncated and were shown in grid filling at the top. Since the reference frequencies were taken in the ambient air, some sensors, such as that with poly(vinyl pyrrolidone) (PVP) coating, contain certain amount of water derived from the ambient humidity. A negative frequency shift (shift to higher frequency) was observed when exposing the PVP-coated sensor to hygroscopic solvents such as THF. As can be seen, the different analyte vapors each resulted in a unique combination of sensor element responses.

### EXAMPLE 6

### Principal Component Analysis of Vapor Sensing Data from a 4-element TSM Sensor Array

Frequency shifts of the sensors elements were monitored and data taken when the frequency shifts of all sensors became steady were used in subsequent analysis. Three consecutive frequency shift data were averaged and were used for further processing. Preprocessing of data for principal component analysis (PCA) consists of two steps as suggested by Nakamura (Nakamura, 2000). First, natural logarithm of partition coefficients was used for PCA. These can be calculated by use of the definition

$$K = \frac{{C}_{p}}{{C}_{g}} = \frac{Δ {f}_{g}}{Δ {f}_{p}} {ρ}_{p} \qquad Equation 6$$

in which Cₚ and C_{g} are the concentrations of analyte in polymer and in the gas phase, respectively. Δf_{g} and Δfₚ are the frequency shifts due to analyte absorption and due to polymer coating, respectively. ρₚ is the density of the polymer. Ideally, several data of various concentrations were taken to (1) verify the linearity of the system and (2) compute K values from the slope of concentration plots. In this experiment, data at only one concentration were taken. Second, In Kᵢⱼ was autoscaled with respect to each of the four polymers

$${( ln {K}_{ij} )}_{auto} = \frac{ln {K}_{ij} - \overline{ln {K}_{j}}}{\sqrt{{\sum }_{i = 1}^{4} {( ln {K}_{ij} - \overline{ln {K}_{j}} )}^{2}}} \qquad Equation 7$$

in which i is the index for the 8 gases, j is the index for the 4 polymers and

$$ln {K}_{j} = \frac{{\sum }_{i = 1}^{4} ln {K}_{ij}}{4} \qquad Equation 8$$

The autoscaled data is then subjected to PCA analysis.

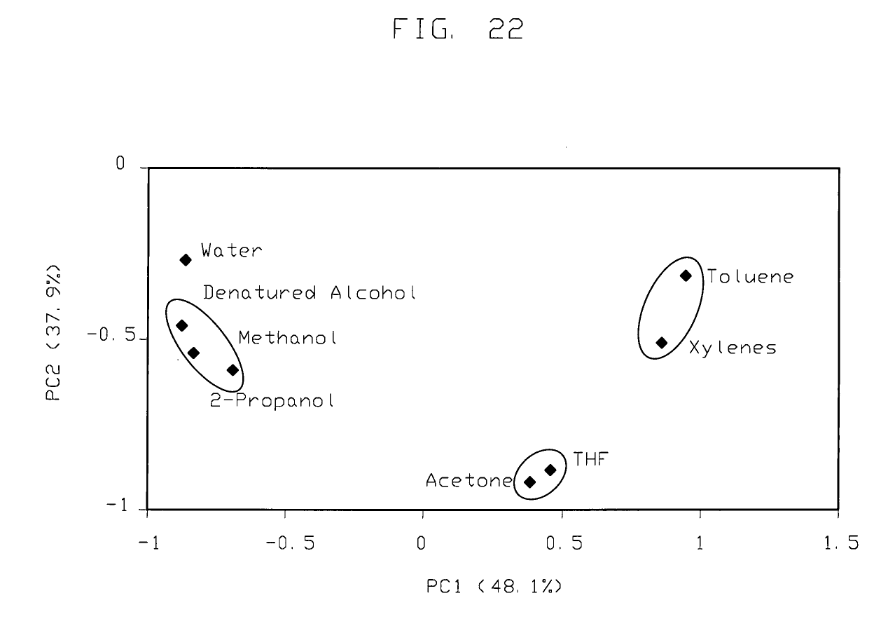

Principal component analysis was calculated using MatLab software (Math Works, Natick, Mass.). FIG. 22 shows the principal component analysis for the four-sensor array in contact with the eight chemical vapors. It is clear, even with a limited set of four polymer coatings, that there are three well-separated clusters in the plot for the first and the second principal components, representing three different solvent groups, namely protic solvents such as alcohols and water, aprotic organic solvents such as ketones and ethers, and nonpolar organics such as aromatic hydrocarbons. Water is at one extreme, and nonpolar hydrocarbons at the other. This demonstrates that classification of unknown vapor analytes with this sensor is possible, placing the unknown into general categories of vapor type.

### EXAMPLE 7

### Operation of a 4-element TSM Sensor Array in Contact with Water

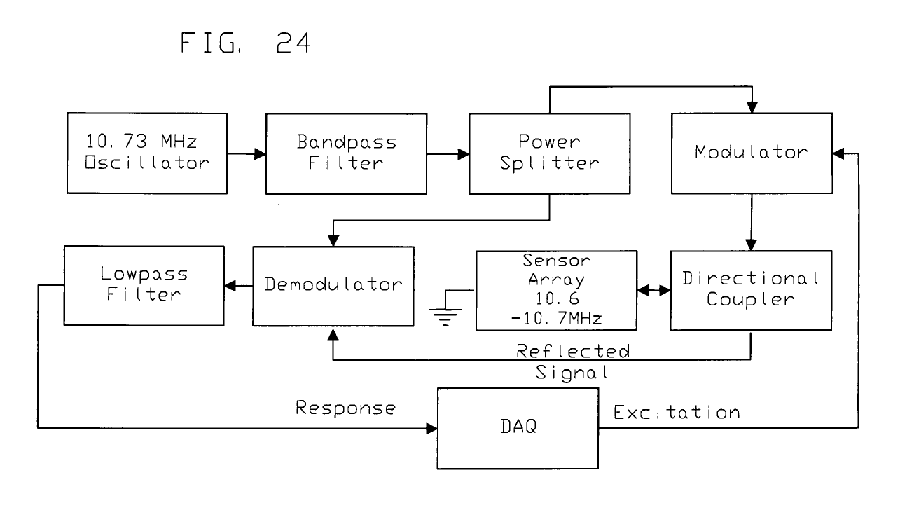

FIG. 23 illustrates one possible configuration of a 4-element frequency encoded TSM sensor array, as applied to aqueous or liquid analyte samples, with sensing layers that bind analytes of interest from a liquid sample. One resonant surface of each sensor element on side of a monolithic array is in direct contact with an aqueous solution. Alternatively, individual TSM devices can be held in a fixture to achieve a similar configuration as the multi-element monolith. The sensor elements are frequency encoded according to the process described previously. The sensor array is configured so that the TSM electrodes of each sensor element in contact with the aqueous sample are connected together and to the electrical ground. This allows the sensor elements to be driven to resonance without electrical interference from other sensor elements and without electrochemical interaction with the analyte sample. The modified analog circuit configuration is shown in FIG. 24. A significant difference between FIG. 14 and FIG. 24 is the use of a directional coupler in the configuration of FIG. 24. By use of a directional coupler, a reflective signal from the parallel-connected array is detected as suggested by Thompson (Thompson, 1991).

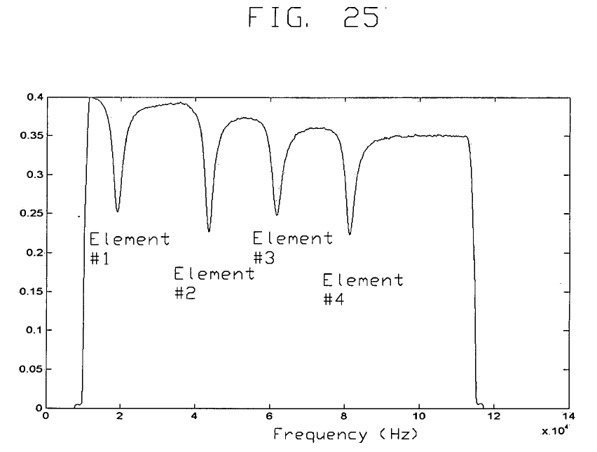

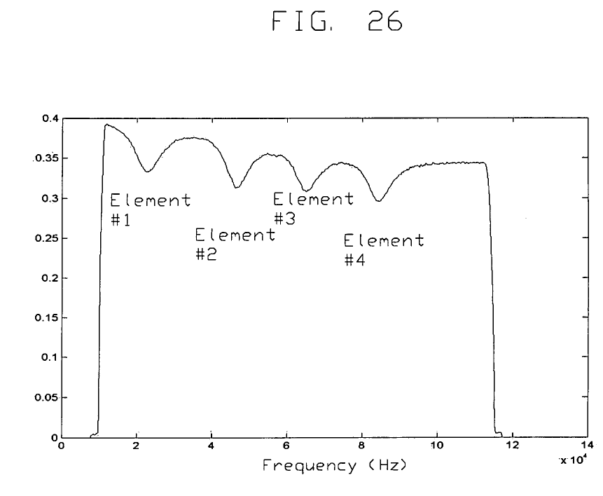

In a demonstration conducted with four individual (initial) 10.73 MHz QCM sensors, nickel electroplating was used for frequency encoding, to have a frequency spacing of approximately 20 kHz between nearest element resonant frequencies. The sensor elements were clamped on a fixture with o-rings on the both sides. The quality factors for the four sensors decreased from above 10,000 in air to about 5000 in the fixture as shown in FIG. 25. The resonant peaks are negative, indicating the fact that there is less power being reflected at resonance. If one side is allowed to contact with water, the q-values are further decreased to about 2000 as shown in FIG. 26. Even with the decreased q-value, there is sufficient signal in this example to demonstrate conclusively that such sensor arrays are useful for measurements in liquid and aqueous media.

### EXAMPLE 8

### Fabrication of High-frequency, Monolithic, Inverted-mesa Structure TSM Sensor Arrays

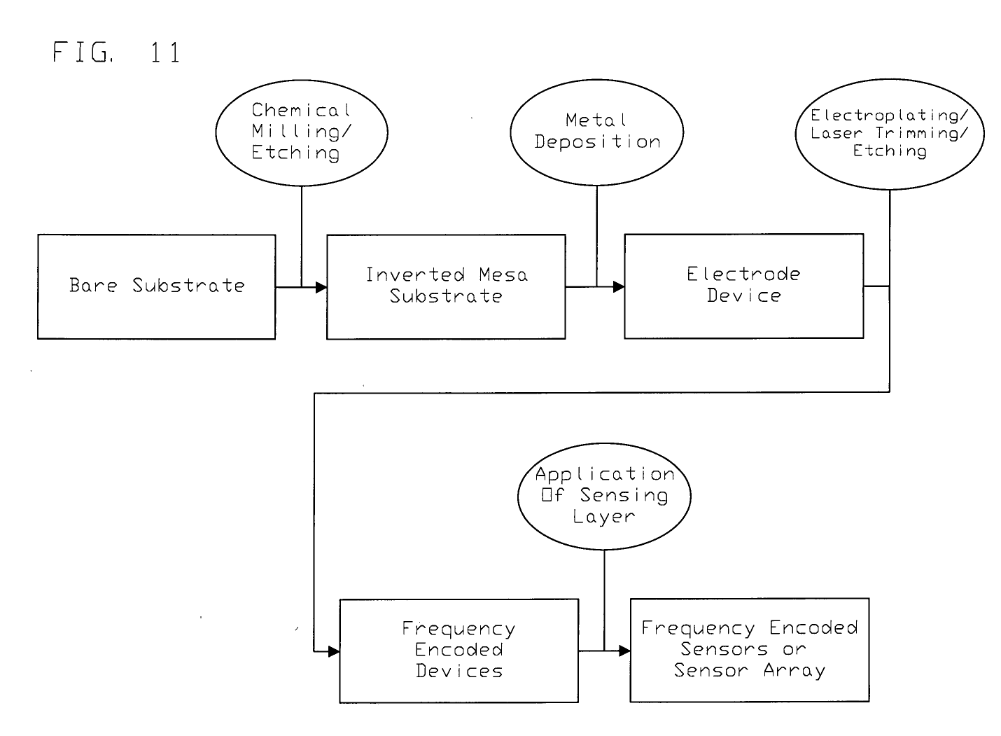

FIG. 11 illustrates the steps in fabricating a monolithic, high-frequency TSM sensor array. These high-frequency sensor elements have intrinsically higher sensitivity to changes in mass than the commercially available lower frequency TSM structures, as apparent from the Sauerbrey equation. The fabrication process begins with bare piezoelectric substrate, such as AT cut quartz of a thickness corresponding to a TSM resonant frequency of approximately 22 MHz. Fluoride-based etching or chemical milling, creates inverted mesa structures in the substrate, with diameter of approximately 2.5 mm, resulting in regions of uniform, thinner substrate corresponding to TSM structures of higher frequency. Target frequency ranges in this example are 50 MHz, 75 MHz, 100 MHz, and 150 MHz. All of the elements in a single substrate are typically etched to the same target thickness and frequency, although precise control of the etching can result in elements with different target frequency ranges, or in elements with similar frequency ranges that are frequency encoded by the etching process. Typically, however, the device elements of identical thickness are patterned with electrodes, in this case circular electrodes centered in each inverted mesa structure of approximately 1 mm diameter. Frequency-encoding is implemented, either as already described by controlling the etching process, or more typically by control of electrode deposition, electroplating or laser trimming of each device element. Sensing layers are then applied to the device elements.

### EXAMPLE 9

### Fabrication and Signal Acquisition for a 21-Element Tuning Fork Sensor Array

An array consisting of 21 tuning fork sensor elements was prepared from commercially available devices, using a diamond abrasive wheel to trim the devices. A target frequency spacing of 200-300 Hz between adjacent sensor devices was achieved. Sensing layer application and signal acquisition from the array is carried out as in Example 1. FIG. 29 shows the magnitude spectrum acquired from this sensor, after SWIFT excitation and FFT analysis of the time domain FOD signal. Sensor elements over the total frequency span of just over 5000 Hz showed good performance and q-values. Pulsed acquisition could be experimentally repeated as desired as fast as once per second, demonstrating that classification of complex mixtures with large numbers of cross-reactive sensor elements is possible, with effectively continuous monitoring of analyte, unlike slower scanning of multiple sensors as known in the prior art, requiring much longer times or multiple independent acquisition channels, to obtain signal from arrays of 20 or more sensor elements. Other methods to fabricate and operate frequency encoded resonant sensor arrays, including arrays with more than 20 sensor elements, will be apparent to those skilled in the art.

From the above examples, it is clear that the combination of the frequency encoding and Fourier transform detection allows for the design of useful sensor arrays for vapor and liquid analyte. The methods of the invention combine simple hardware construction and high analysis speed. It is to be understood that the above descriptions and examples are intended to be illustrative rather than restrictive, and that many other embodiments of the invention will be apparent to those skilled in the art upon reading this description. The scope of this invention should be determined with reference to the appended claims, with consideration of the full scope of equivalents to which such claims are entitled. Other embodiments are also within the claims.

1. A method for the detection of analytes by use of resonant sensors or sensor arrays, the method comprising:
frequency encoding multiple sensor elements of the sensor array;
acquiring frequency spectral data for the array as it is exposed to analyte; and
classifying, identifying, and/or quantifying analyte by use of an appropriate data analysis procedure.

2. The method of claim 1 wherein the resonant sensor array comprises an array of piezoelectric elements or cantilever elements.

3. The method of claim 2 wherein the piezoelectric elements are tuning fork elements, thickness shear mode (TSM) or quartz crystal microbalance (QCM) elements, or surface acoustic wave (SAW) elements.

4. The method of claim 1 wherein multiple frequency encoded sensor elements are derived from initially identical devices that are modified such that their resonant signals can be identified under sensing conditions.

5. The method of claims 3 or 4 wherein an array of piezoelectric tuning fork sensors is frequency encoded by shortening tines of initially identical sensor elements to different lengths to separate their resonant frequencies.

6. The method of claim 3 or 4 wherein an array of tuning fork sensors, an array of thickness shear mode (TSM) or quartz crystal microbalance (QCM) sensors, or an array of surface acoustic wave (SAW) sensors is frequency encoded by depositing different thicknesses of rigid material on individual sensor elements to separate their frequencies.

7. The method of claim 6 wherein an array of tuning fork sensors or an array of thickness shear mode (TSM) or quartz crystal microbalance (QCM) sensors is frequency encoded by electroplating different thicknesses of rigid metal on one or more electrodes of individual sensor elements to separate their frequencies.

8. The method of claim 1 wherein multiple frequency encoded sensor elements are derived from devices fabricated with unique, resolvable resonant frequencies.

9. The method of claim 8 wherein a frequency encoded tuning fork sensor array comprises multiple resonant sensor elements microfabricated with unique geometries.

10. The method of claim 8 wherein a frequency encoded thickness shear mode (TSM) or quartz crystal microbalance (QCM) sensor array comprises sensor elements with unique substrate thicknesses or unique deposited electrode thicknesses.

11. The method of claim 8 wherein a frequency encoded surface acoustic wave (SAW) sensor array comprises sensor elements with unique interdigitated electrode spacing.

12. The method of claim 1 wherein frequency spectral data is acquired by a pulse/acquisition method comprising:
pulsing the sensor array with an excitation waveform;
acquiring time domain free oscillation decay (FOD) signal;
converting the time domain signal into frequency data.

13. The method of claim 1 wherein frequency spectral data is acquired by a rapid scan method comprising:
applying an excitation waveform to the sensor array;
acquiring time domain signal simultaneously with application of the excitation waveform;
converting the time domain signal into frequency data.

14. The method of claim 1 wherein frequency spectral data is acquired by a-frequency sweeping method comprising:
exciting the sensor array with a frequency sweep signal which varies in frequency over time;
acquiring the array's frequency response simultaneously with the excitation sweep.

15. The method of claim 1 wherein acquisition of frequency spectral data from the frequency encoded sensor array comprises recording a signal from the array as individual sensor elements are driven by individual oscillators dedicated to each sensor element.

16. The method of claim 12, 13, 14, or 15 wherein acquisition of signal from the encoded array is carried out in either a direct mode or a heterodyne mode.

17. The method of claim 12, 13, or 14 wherein excitation of the sensor array is carried out in a direct mode or in a heterodyne mode.

18. The method of claim 12 or 13 wherein the excitation waveform is a stored waveform inverse Fourier transform (SWIFT) waveform.

19. The method of claim 12 or 13 wherein the excitation waveform is a frequency sweep or chirp waveform.

20. The method of claim 12 or 13 wherein the excitation waveform is an impulse waveform.

21. The method of claim 12 wherein time domain signal is converted into frequency data using fast Fourier transform (FFT).

22. The method of claim 1 wherein the analyte comprises gas phase chemical vapors.

23. The method of claim 1 or 22 wherein various sensor elements of the sensor array each comprise unique sensing layers comprising unique polymers or other sensing materials.

24. The method of claim 1, 2 or 23 wherein data analysis procedures for classifying, identifying, or quantifying analyte comprise
extracting resonant peak information for each sensor element including peak frequency
classifying, identifying, and/or quantifying analyte by use of a multivariate data analysis procedure.

25. The method of claim 1 wherein the analyte is in liquid phase.

26. The method of claim 3 wherein tuning fork sensor elements are connected to form a two-port equivalent device by parallel connection.

27. The method of claim 3 wherein thickness shear mode (TSM) or quartz crystal microbalance (QCM) sensor elements are connected to form a two-port equivalent device by parallel connection, serial connection, or serial connection with capacitor ladder.

28. The method of claim 3 wherein thickness shear mode (TSM) or quartz crystal microbalance (QCM) sensor elements are connected to form a two-port equivalent device by parallel connection through a directional coupler.

29. A frequency encoded resonant sensor array comprising multiple sensor elements that produce unique, identifiable resonance signals at different frequencies.

30. The array of claim 29 wherein each sensor element comprises a resonant device and a sensing layer.

31. The array of claim 29 wherein the sensor elements comprise piezoelectric resonant elements.

32. The array of claim 31 wherein the sensor elements comprise tuning fork elements, thickness shear mode (TSM) or quartz crystal microbalance (QCM) elements, or surface acoustic wave (SAW) elements.

33. The array of claim 29 wherein the sensor elements are derived from initially identical devices that are modified such that their resonant signals can be resolved under sensing conditions.

34. The array of claim 29 wherein the sensor elements are derived from devices fabricated with unique, resolvable resonant frequencies.

35. The array of claim 29 or claim 32 comprising four (4) or more sensor elements.

36. The array of claim 29 or claim 32 comprising ten (10) or more sensor elements.

37. The array of claim 29 or claim 32 comprising twenty (20) or more sensor elements.

38. They array of claim 30 wherein multiple sensor elements comprise unique sensing layers with diverse affinities toward analytes.

39. The array of claim 30 wherein multiple sensor elements comprise identical sensing layers with identical affinities toward analytes.

40. The array of claim 30 wherein multiple sensor elements comprise a combination of identical sensing layers with identical affinities and unique sensing layers with diverse affinities toward analytes

41. The array of claim 29 or claim 32 wherein multiple sensor elements are connected to form a two-port equivalent device.

42. The array of claim 29 wherein individual sensor elements are driven by individual oscillators dedicated to each sensor element.
